(19) United States
(12) Patent Application Publication
(10) Pub. No.: US 2026/0055299 A1
(43) Pub. Date: Feb. 26, 2026

(54) Curable Photochromic Compositions Including Hydrazide and Carbonyl Functional Components

(71) Applicant: Transitions Optical, Ltd., Tuam (IE)

(72) Inventors: Ramaiahgari Reddy, Murrysville, PA (US); Anil Kumar, Murrysville, PA (US); Yannian Li, Solon, OH (US)

(21) Appl. No.: 18/998,870

(22) PCT Filed: Jul. 28, 2022
(86) PCT No.: PCT/EP2022/071153

§ 371 Date: Jan. 27, 2025

(51) Int. Cl. C09D 187/00; C08G 81/02; C09D 5/29

(52) U.S. Cl. CPC C09D 187/005; C08G 81/027; C09D 5/29

(57) ABSTRACT

The present invention relates to, a curable photochromic composition that includes: (a) a photochromic compound; (b) a hydrazide functional material having at least two hydrazide groups that are reactive with carbonyl groups selected from ketone groups and aldehyde groups; (c) a first carbonyl-functional component including a (meth)acrylate polymer having at least two carbonyl groups that are reactive with hydrazide groups; and (d) at least one of, (d1) a second carbonyl-functional component having at least one carbonyl group that is reactive with hydrazide groups, and/or (d2) a non-reactive component. The non-reactive component is free of functional groups that are reactive with the hydrazide functional material, the first carbonyl-functional component, and the second carbonyl-functional component. The present invention also relates to an article that includes: a substrate; and a photochromic layer over at least one surface of the substrate, where the photochromic layer is formed from the curable photochromic composition of the present invention.

### FIELD

The present invention relates to curable photochromic compositions, which include: a photochromic compound; a hydrazide functional material having at least two hydrazide groups; a first carbonyl-functional component including a (meth)acrylate polymer having at least two carbonyl groups; and at least one of, a second carbonyl-functional component having at least one carbonyl group, and/or a non-reactive component.

### BACKGROUND

In response to certain wavelengths of electromagnetic radiation (or “actinic radiation”), photochromic compounds, such as indeno-fused naphthopyrans, typically undergo a transformation from one form or state to another form, with each form having a characteristic or distinguishable absorption spectrum associated therewith. Typically, upon exposure to actinic radiation, many photochromic compounds are transformed from a closed-form, which corresponds to an unactivated (or bleached, e.g., substantially colorless) state of the photochromic compound, to an open-form, which corresponds to an activated (or colored) state of the photochromic compound. In the absence of exposure to actinic radiation, such photochromic compounds are reversibly transformed from the activated (or colored) state, back to the unactivated (or bleached) state. Compositions and articles, such as optical lenses, that contain photochromic compounds or have photochromic compounds applied thereto (e.g., in form of a photochromic coating composition) typically display colorless (e.g., clear) and colored states that correspond to the colorless and colored states of the photochromic compounds contained therein or applied thereto.

Photochromic compounds can be used in curable compositions to form, for example, cured layers, such as cured films or sheets that are photochromic. With cured photochromic films, such as cured photochromic coatings, it is typically desirable that they provide a combination of hardness and photochromic performance. Generally, the kinetics associated with the reversible transformation of a photochromic compound between a closed-form (unactivated/colorless) and an open-form (activated/colored) is faster in a soft matrix, but slower in a hard matrix (of the cured film in which the photochromic compound resides). Cured photochromic films having a soft matrix typically have reduced hardness, while those having a hard matrix typically have increased hardness.

It would be desirable to develop curable photochromic compositions that provide cured photochromic layers having improved hardness without a reduction in photochromic performance.

### SUMMARY

In accordance with the present invention, there is provided a curable photochromic composition comprising: (a) a photochromic compound; (b) a hydrazide functional material comprising at least two hydrazide groups that are reactive with carbonyl groups selected from ketone groups and aldehyde groups; and (c) a first carbonyl-functional component comprising a (meth)acrylate polymer having at least two carbonyl groups that are reactive with hydrazide groups, wherein each carbonyl group of the first carbonyl-functional component is independently selected from ketone groups and aldehyde groups. The curable photochromic composition further comprises (d) at least one of: (d1) a second carbonyl-functional component comprising at least one carbonyl group that is reactive with hydrazide groups, wherein the second carbonyl-functional component comprises at least one of polycarbonate carbonyl, polyester carbonyl, polyether carbonyl, polyurethane carbonyl, or combinations thereof, wherein each carbonyl group of the second carbonyl-functional component is independently selected from ketone groups and aldehyde groups; and/or (d2) a non-reactive component. The non-reactive component is free of functional groups that are reactive with (form covalent bonds with) the hydrazide functional material, the first carbonyl-functional component, and the second carbonyl-functional component.

In accordance with the present invention, there is further provided an article comprising: (A) a substrate; and (B) a photochromic layer over at least one surface of the substrate, wherein the photochromic layer is formed from the curable photochromic composition of the present invention, as described above and further herein.

The features that characterize the present invention are pointed out with particularity in the claims, which are annexed to and form a part of this disclosure. These and other features of the invention, its operating advantages and the specific objects obtained by its use will be more fully understood from the following detailed description in which non-limiting embodiments of the invention are illustrated and described.

### DETAILED DESCRIPTION

As used herein, the articles “a,” “an,” and “the” include plural referents unless otherwise expressly and unequivocally limited to one referent.

Unless otherwise indicated, all ranges or ratios disclosed herein are to be understood to encompass any and all values, and subranges or subratios subsumed therein. For example, a stated range or ratio of “1 to 10” should be considered to include: any and all values there-between, including the stated terminal values (such as 1, 2, 3, 4, 5, 6, 7, 8, 9, and 10); and subranges between (and inclusive of) the minimum value of 1 and the maximum value of 10, that is, all subranges or subratios beginning with a minimum value of 1 or more and ending with a maximum value of 10 or less, such as but not limited to, 1 to 6.1, 3.5 to 7.8, and 5.5 to 10.

As used herein, unless otherwise indicated, left-to-right representations of linking groups, such as divalent linking groups, are inclusive of other appropriate orientations, such as, but not limited to, right-to-left orientations. For purposes of non-limiting illustration, the left-to-right representation of the divalent linking group

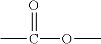

or equivalently —C(O)O—, is inclusive of the right-to-left representation thereof,

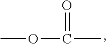

or equivalently —O(O)C— or —OC(O)—.

Other than in the operating examples, or where otherwise indicated, all numbers expressing quantities of ingredients, reaction conditions, and so forth used in the specification and claims are to be understood as modified in all instances by the term “about.”

As used herein, molecular weight values of polymers, such as weight average molecular weights (Mw) and number average molecular weights (Mn), are determined by gel permeation chromatography (GPC) in an appropriate solvent (such as dimethylformamide DMF or tetrahydrofuran THF) and using appropriate standards, such as polystyrene standards.

As used herein, polydispersity index (PDI) values represent a ratio of the weight average molecular weight (Mw) to the number average molecular weight (Mn) of the polymer (i.e., Mw/Mn).

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means methacrylates and/or acrylates. As used herein, the term “(meth)acrylic acid” means methacrylic acid and/or acrylic acid.

As used herein, the term “photochromic” and similar terms, such as “photochromic compound” means having an absorption spectrum for at least visible radiation that varies in response to absorption of at least actinic radiation. Further, as used herein the term “photochromic material” means any substance that is adapted to display photochromic properties (such as, adapted to have an absorption spectrum for at least visible radiation that varies in response to absorption of at least actinic radiation) and which includes at least one photochromic compound.

As used herein, the term “actinic radiation” means electromagnetic radiation that is capable of causing a response in a material, such as, but not limited to, transforming a photochromic material from one form or state to another as will be discussed in further detail herein.

As used herein, the term “photochromic material” includes thermally reversible photochromic materials and compounds and non-thermally reversible photochromic materials and compounds. The term “thermally reversible photochromic compounds/materials” as used herein means compounds/materials capable of converting from a first state, for example a “clear state,” to a second state, for example a “colored state,” in response to actinic radiation, and reverting back to the first state in response to thermal energy. The term “non-thermally reversible photochromic compounds/materials” as used herein means compounds/materials capable of converting from a first state, for example a “clear state,” to a second state, for example a “colored state,” in response to actinic radiation, and reverting back to the first state in response to actinic radiation of substantially the same wavelength(s) as the absorption(s) of the colored state.

As used herein to modify the term “state,” the terms “first” and “second” are not intended to refer to any particular order or chronology, but instead refer to two different conditions or properties. For purposes of non-limiting illustration, the first state and the second state of a photochromic compound can differ with respect to at least one optical property, such as but not limited to the absorption of visible and/or UV radiation. Thus, according to various non-limiting embodiments disclosed herein, the photochromic compounds of the present invention can have a different absorption spectrum in each of the first and second states. For example, while not limiting herein, a photochromic compound of the present invention can be clear in the first state and colored in the second state. Alternatively, a photochromic compound of compositions of the present invention can have a first color in the first state and a second color in the second state.

As used herein the term “optical” means pertaining to or associated with light and/or vision. For example, according to various non-limiting embodiments disclosed herein, the optical article or element or device can be chosen from ophthalmic articles, elements and devices, display articles, elements and devices, windows, mirrors, and active and passive liquid crystal cell articles, elements and devices.

As used herein the term “ophthalmic” means pertaining to or associated with the eye and vision. Non-limiting examples of ophthalmic articles or elements include corrective and non-corrective lenses, including single vision or multi-vision lenses, which can be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors.

As used herein the term “display” means the visible or machine-readable representation of information in words, numbers, symbols, designs or drawings. Non-limiting examples of display elements include screens, monitors, and security elements, such as security marks.

As used herein the term “window” means an aperture adapted to permit the transmission of radiation there-through. Non-limiting examples of windows include automotive and aircraft transparencies, windshields, filters, shutters, and optical switches.

As used herein the term “mirror” means a surface that specularly reflects a large fraction of incident light.

As used herein the term “liquid crystal cell” refers to a structure containing a liquid crystal material that is capable of being ordered. A non-limiting example of a liquid crystal cell element is a liquid crystal display.

As used herein, spatial or directional terms, such as “left”, “right”, “inner”, “outer”, “above”, “below”, and the like, relate to various orientations of the invention as may be described further herein, such as articles and multilayer articles of the present invention. It is to be understood, however, that the invention can assume various alternative orientations to those described herein and, accordingly, such terms are not to be considered as limiting.

As used herein, the terms “formed over,” “deposited over,” “provided over,” “applied over,” residing over,” or “positioned over,” mean formed, deposited, provided, applied, residing, or positioned on but not necessarily in direct (or abutting) contact with the underlying element, or surface of the underlying element. For example, a layer “positioned over” a substrate does not preclude the presence of one or more other layers, coatings, or films of the same or different composition located between the positioned or formed layer and the substrate.

All documents, such as but not limited to issued patents and patent applications, referred to herein, and unless otherwise indicated, are to be considered to be “incorporated by reference” in their entirety.

As used herein, recitations of “linear or branched” groups, such as linear or branched alkyl, are herein understood to include: a methylene group or a methyl group; groups that are linear, such as linear C₂-C₂₀ alkyl groups; and groups that are appropriately branched, such as branched C₃-C₂₀ alkyl groups.

The term “alkyl” as used herein means linear or branched, cyclic or acyclic C₁-C₂₅ alkyl. Linear or branched alkyl can include C₁-C₂₅ alkyl, such as C₁-C₂₀ alkyl, such as C₂-C₁₀ alkyl, such as C₁-C₁₂ alkyl, such as C₁-C₆ alkyl. Examples of alkyl groups from which the various alkyl groups of the present invention can be selected from, include, but are not limited to, those recited further herein. Alkyl groups can include “cycloalkyl” groups. The term “cycloalkyl” as used herein means groups that are appropriately cyclic, such as, but not limited to, C₃-C₁₂ cycloalkyl (including, but not limited to, cyclic C₃-C₁₀ alkyl, or cyclic C₅-C₇ alkyl) groups. Examples of cycloalkyl groups include, but are not limited to, those recited further herein. The term “cycloalkyl” as used herein also includes: bridged ring polycycloalkyl groups (or bridged ring polycyclic alkyl groups), such as, but not limited to, bicyclo[2.2.1]heptyl (or norbornyl) and bicyclo[2.2.2]octyl; and fused ring polycycloalkyl groups (or fused ring polycyclic alkyl groups), such as, but not limited to, octahydro-1H-indenyl, and decahydronaphthalenyl.

The term “heterocycloalkyl” as used herein means groups that are appropriately cyclic, such as, but not limited to, C₂-C₁₂ heterocycloalkyl groups, such as C₂-C₁₀ heterocycloalkyl groups, such as C₅-C₇ heterocycloalkyl groups, and which have at least one hetero atom in the cyclic ring, such as, but not limited to, O, S, N, P, and combinations thereof. Examples of heterocycloalkyl groups include, but are not limited to, imidazolyl, tetrahydrofuranyl, tetrahydropyranyl and piperidinyl. The term “heterocycloalkyl” as used herein also includes: bridged ring polycyclic heterocycloalkyl groups, such as, but not limited to, 7-oxabicyclo[2.2.1]heptanyl; and fused ring polycyclic heterocycloalkyl groups, such as, but not limited to, octahydrocyclopenta[b]pyranyl, and octahydro-1H-isochromenyl.

The descriptions, classes, and examples provided herein with regard to alkyl groups, cycloalkyl groups, heterocycloalkyl groups, haloalkyl groups, and the like, are also applicable to alkane groups, cycloalkane groups, heterocycloalkane groups, haloalkane groups, etc., such as, but not limited to, polyvalent alkane groups, such as polyvalent alkane linking groups, such as divalent alkane linking groups.

As used herein, the term “aryl” and related terms, such as “aryl group”, means an aromatic cyclic monovalent hydrocarbon radical. As used herein, the term “aromatic” and related terms, such as “aromatic group,” means a cyclic conjugated hydrocarbon having stability (due to delocalization of pi-electrons) that is significantly greater than that of a hypothetical localized structure. Examples of aryl groups include C₆-C₁₄ aryl groups, such as, but not limited to, phenyl, naphthyl, phenanthryl, and anthracenyl.

The term “heteroaryl”, as used herein, includes, but is not limited to, C₃-C₁₅ heteroaryl, such as, but not limited to, C₃-C₁₀ heteroaryl (including fused ring polycyclic heteroaryl groups) and means an aryl group having at least one hetero atom in the aromatic ring, or in at least one aromatic ring in the case of a fused ring polycyclic heteroaryl group. Examples of heteroaryl groups include, but are not limited to, furanyl, pyranyl, pyridinyl, quinolinyl, isoquinolinyl, and pyrimidinyl.

The term “aralkyl”, as used herein, includes, but is not limited to, C₆-C₂₄ aralkyl, such as, but not limited to, C₆-C₁₀ aralkyl, and means an alkyl group substituted with an aryl group. Examples of aralkyl groups include, but are not limited to, benzyl and phenethyl.

Representative alkyl groups include, but are not limited to, methyl, ethyl, propyl, isopropyl, butyl, isobutyl, sec-butyl, tert-butyl, pentyl, neopentyl, hexyl, heptyl, octyl, nonyl and decyl. Representative alkenyl groups include, but are not limited to, vinyl, allyl, and propenyl. Representative alkynyl groups include, but are not limited to, ethynyl, 1-propynyl, 2-propynyl, 1-butynyl, and 2-butynyl. Representative cycloalkyl groups include, but are not limited to, cyclopropyl, cyclobutyl, cyclopentyl, cyclohexyl, and cyclooctyl.

As used herein, the term “halo” and related terms, such as “halo group,” “halo substituent,” “halogen group,” and “halogen substituent,” means a single bonded halogen group, such as —F, —Cl, —Br, and —I.

As used herein, recitations of “halo substituted” and related terms (such as, but not limited to, haloalkyl groups, haloalkenyl groups, haloalkynyl groups, haloaryl groups, and halo-heteroaryl groups) means a group in which at least one, and up to and including all of the available hydrogen groups thereof is substituted with a halo group, such as, but not limited to F, Cl or Br. The term “halo-substituted” is inclusive of “perhalo-substituted.”

As used herein, “at least one of” is synonymous with “one or more of,” whether the elements are listed conjunctively or disjunctively. For example, phrases such as “at least one of A, B, and C” and “at least one of A, B, or C” each mean any one of A, B, or C, or any combination of any two or more of A, B, or C. For example, A alone; or B alone; or C alone; or A and B; or A and C; or B and C; or all of A, B, and C.

As used herein, “selected from” is synonymous with “chosen from” whether the elements are listed conjunctively or disjunctively. For example, phrases such as “selected from A, B, and C” and “selected from A, B, or C” each mean any one of A, B, or C, or any combination of any two or more of A, B, or C. For example, A alone; or B alone; or C alone; or A and B; or A and C; or B and C; or all of A, B, and C.

As used herein, and in accordance with some embodiments, the term “ketone” such as with regard to groups, and substituents of various groups, of the compounds and components of the present invention, and related terms, such as “ketone group,” “keto group,” “ketone substituent,” and “keto substituent” includes a material represented by —C(O)R, where R is selected from those groups as described below, other than hydrogen.

As used herein, and in accordance with some embodiments, the term “aldehyde” such as with regard to groups, and substituents of various groups, of the compounds and components of the present invention, and related terms, such as “aldehyde group,” “aldo group,” “aldehyde substituent,” and “aldo substituent” includes a material represented by —C(O)H.

As used herein, and in accordance with some embodiments, the term “carboxylic acid” such as with regard to groups, and substituents of various groups, of the compounds and components of the present invention, and related terms, such as “carboxylic acid group” and “carboxylic acid substituent” includes a material represented by —C(O)OH.

As used herein, and in accordance with some embodiments, the term “ester” such as with regard to groups, and substituents of various groups, of the compounds and components of the present invention, and related terms, such as “ester group” and “ester substituent” means a carboxylic acid ester group represented by —C(O)OR, where R is selected from those groups as described below, other than hydrogen.

As used herein, and in accordance with some embodiments, the term “carboxylate” such as with regard to groups, and substituents of various groups, of the compounds and components of the present invention, and related terms, such as “carboxylate group” and “carboxylate substituent,” includes a material represented by —OC(O)R, where R is selected from those groups as described below.

As used herein, and in accordance with some embodiments, the term “amide” such as with regard to groups, and substituents of various groups, of the compounds and components of the present invention, and related terms, such as “amide group” and “amide substituent” includes a material represented by —C(O)N(R)(R) or —N(R)C(O)R, where each R is independently selected from those groups as described below.

As used herein, and in accordance with some embodiments, the term “carbonate” such as with regard to groups, and substituents of various groups, of the compounds and components of the present invention, and related terms, such as “carbonate group” and “carbonate substituent” includes a material represented by —OC(O)OR, where R is selected from those groups as described below, other than hydrogen.

As used herein, and in accordance with some embodiments, the term “urethane,” such as with regard to groups, and substituents of various groups, of the compounds and components of the present invention, and related terms, such as “urethane group,” and “urethane substituent,” includes a material represented by —OC(O)N(R)(H) or —N(H)C(O)OR, where R in each case is independently selected from those groups as described below, other than hydrogen.

As used herein, and in accordance with some embodiments, the term “urea” such as with regard to groups, and substituents of various groups, of the compounds and components of the present invention, and related terms, such as “urea group” and “urea substituent” includes a material represented by —N(R)C(O)N(R)(R), where each R is independently selected from those groups as described below.

As used herein, and in accordance with some embodiments, the term “siloxy” such as with regard to groups, and substituents of various groups, of the compounds and components of the present invention, and related terms, such as “siloxy group” and “siloxy substituent” includes a material represented by —O—Si(R)₃ where each R is independently selected from those groups as described below, other than hydrogen.

Unless otherwise stated, each R group of each of the above described ketone, ester (carboxylic acid ester), carboxylate, amide, carbonate, urethane, urea, and siloxy, is in each case independently selected from hydrogen, alkyl, haloalkyl, perhaloalkyl, cycloalkyl, heterocycloalkyl, aryl, heteroaryl, and combinations thereof (including those classes and examples thereof as recited previously herein).

The photochromic compositions of the present invention include a hydrazide functional material having at least two hydrazide groups that are in each case reactive with carbonyl groups selected from ketone groups and aldehyde groups. As used herein, by “reactive with carbonyl groups selected from ketone groups and aldehyde groups” and similar recitations, means the hydrazide groups and the ketone groups and/or aldehyde groups react together to form a covalent bond or linkage there-between, such as a hydrazone linkage.

In accordance with some embodiments of the present invention, each hydrazide group of the hydrazide functional material is in each case independently selected from: an acyl hydrazide group (—C(O)—NHNH₂); a sulfono hydrazide group (—S(O)(O)—NHNH₂); and a phosphinic hydrazide group (—P(O)(R′)—NHNH₂) where R′ is in each case independently selected from alkyl, haloalkyl, perhaloalkyl, cycloalkyl, heterocycloalkyl, aryl, heteroaryl, and combinations thereof (including those classes and examples thereof as recited previously herein). Each hydrazide group of the hydrazide functional material, with some embodiments, is in each case an acyl hydrazide group (—C(O)—NHNH₂).

With some embodiments, the hydrazide functional material has a hydrazide equivalent weight of from 250 g/mole to 10,000 g/mole, or from 300 g/mole to 8000 g/mole, or from 500 g/mole to 5000 g/mole. The hydrazide functional material, with some further embodiments, has a Mw of 500 g/mole to 50,000 g/mole, or from 1000 g/mole to 40,000 g/mole, or from 2000 g/mole to 40,000 g/mole, as measured by GPC in DMF/LiBr eluent with polystyrene standards.

The hydrazide functional material, with some embodiments, includes from 2 to 60 hydrazide groups, or from 2 to 55 hydrazide groups, or from 2 to 50 hydrazide groups, where the hydrazide groups are in each case reactive with carbonyl groups selected from ketone groups and aldehyde groups.

The hydrazide functional material, with some embodiments, includes at least one of a nonpolymeric hydrazide functional material and/or a polymeric hydrazide functional material. Nonpolymeric hydrazide functional materials, with some embodiments, are free of repeating monomer units (or monomer residues), which are the same or different. Polymeric hydrazide functional materials, with some embodiments, include a plurality of monomer units (or monomer residues).

Examples of nonpolymeric hydrazide functional materials that can be included in the curable photochromic compositions of the present invention include, but are not limited to: fumeric acid dihydrazide; maleic acid dihydrazide; itaconic acid dihydrazide; phthalic acid dihydrazide; terephthalic acid dihydrazide; trimellitic acid trihydrazide; oxalic acid dihydrazide; succinic acid dihydrazide; 2-methylsuccinic acid dihydrazide; adipic acid dihydrazide; sebacic acid dihydrazide; cyclohexane dicarboxylic acid dihydrazide; and cyclohexane tricarboxylic acid trihydrazide.

Hydrazide functional polymers (or polymeric hydrazides) that can be used in the curable photochromic compositions of the present invention can have any suitable polymer backbone, which can have any suitable architecture, such as linear, branched, hyperbranched, star, and comb architectures. Examples of polymer backbones of the hydrazide functional polymers include, but are not limited to, polyethers, polyesters, polycarbonates, polyurethanes, and combinations of two or more thereof. With some embodiments, the hydrazide functional polymer can include one or more substituents, in addition to the hydrazide groups, such as hydroxyl (—OH), carboxylic acid (—C(O)—OH), carboxylic acid ester (—C(O)—OR), sulfonic acid, sodium sulfonate, and/or amino (—N(R)(R)) groups, where each R is independently selected from those groups described previously herein.

With some further embodiments, the hydrazide functional polymers include one or more linking groups (or linkages), where each linking group is in each case independently selected from: ether linkages (—O—); thioether linkages (—S—); urea linkages (—N(R)—C(O)—N(R)—, where each R is independently as described above); carbonate linkages (—O—C(O)—O—); carboxylic acid ester linkages (—O—C(O)—); urethane linkages (—N(H)—C(O)—O—); thiourethane linkages (—S—C(O)—N(H)—); thiourea linkages (—N(R)—C(S)—N(R)—, where each R is independently as described above); and amide linkages (—C(O)—N(R)—, where R is as described above).

With some embodiments, the hydrazide functional material includes a polyurethane including at least two hydrazide groups that are reactive with carbonyl groups selected from ketone groups and aldehyde groups. The hydrazide functional material including a polyurethane which includes at least two hydrazide groups, can be referred to herein as a hydrazide functional polyurethane.

In accordance with some embodiments, the hydrazide functional material is represented by the following Formula (I):

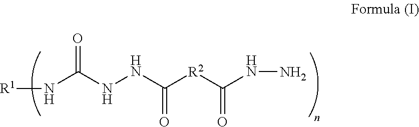

With reference to Formula (I), R¹ is a residue of a polymer, such as a polyether, polyester, polycarbonate, and/or polyurethane. With some embodiments, R¹ of Formula (I), optionally includes one or more substituents, such as, hydroxyl (—OH), carboxylic acid (—C(O)—OH), carboxylic acid ester (—C(O)—OR), sulfonic acid, sodium sulfonate, and/or amino (—N(R)(R)) groups, where R in each case is independently selected from those groups described previously herein. With further reference to Formula (I), R², independently for each n, is: a linear or branched divalent alkane, such as a divalent linear or branched C₁-C₁₀ alkane; a divalent cycloalkane group, such as a divalent C₅-C₈ cycloalkane group; or a divalent aromatic group, such as a divalent C₆-C₁₀ aromatic group. With additional reference to Formula (I), n is from 2 to 60, such as from 2 to 55, or from 2 to 50, from 2 to 40, or 2 or 30.

In accordance with some embodiments, R¹ of Formula (I) is a residue of a polyurethane. With some further embodiments, R¹ of Formula (I) is a residue of an isocyanate terminated polyurethane.

With some embodiments, at least some hydrazide groups of the hydrazide functional material are independently and reversibly blocked with an aldehyde or a ketone. With some further embodiments, at least some hydrazide groups of the hydrazide functional material are independently and reversibly blocked with an aldehyde having a formula weight of less than 250 g/mole (such as from 44 g/mole to less than 250 g/mole), or a ketone having a formula weight of less than 250 g/mole (such as from 58 g/mole to less than 250 g/mole). Examples of aldehyde blocking groups include, but are not limited to, methyl aldehyde, ethyl aldehyde, propyl aldehyde, butyl aldehyde, pentyl aldehyde, hexyl aldehyde, cyclohexyl formaldehyde, and benzaldehyde. Examples of ketone blocking groups include, but are not limited to, dimethyl ketone, methyl ethyl ketone, diethyl ketone, cyclopentanone, ethyl acetoacetate, and acetophenone.

As used herein, and in accordance with some embodiments, “at least some hydrazide groups of the hydrazide functional material being independently and reversibly blocked with an aldehyde or a ketone,” means at least 10%, or at least 20%, or at least 25%, or at least 50%, or at least 75%, or at least 90%, or at least 95%, or 100% of the hydrazide groups are reversibly blocked. As used herein, and in accordance with some embodiments, by “reversibly blocked with an aldehyde or a ketone” means that the blocked hydrazide group becomes an unblocked or free hydrazide group under controlled conditions, such as at elevated temperature, in which case the aldehyde blocking groups and/or ketone blocking groups can volatilize out of, or plasticize, the curable photochromic composition, such as when the curable photochromic composition is in the form of a layer.

The curable photochromic composition, with some embodiments, has a ratio, of (i) total carbonyl equivalents of the first carbonyl-functional component and the second carbonyl-functional component to (ii) total equivalents of hydrazide equivalents of the hydrazide functional material, that is from 1:0.8 to 1:4, or from 1:0.8 to 1:3, or from 1:1 to 1:2.

The first carbonyl-functional component, of the curable photochromic compositions of the present invention, includes a (meth)acrylate polymer having at least two carbonyl groups that are reactive with hydrazide groups, where each carbonyl group is independently selected from ketone groups and aldehyde groups.

The monomers from which the (meth)acrylate polymer of the first carbonyl-functional component is prepared include, but are not limited to: C₁-C₂₀ (meth)acrylates that are free of carbonyl groups that are reactive with the hydrazide groups of the hydrazide functional material; ethylenically unsaturated radically polymerizable monomers having one or more carbonyl groups that are reactive with the hydrazide groups of the hydrazide functional material; and optionally ethylenically unsaturated radically polymerizable monomers, other than (meth)acrylates, that are free of carbonyl groups that are reactive with the hydrazide groups of the hydrazide functional material. The C₁-C₂₀ groups of the (meth)acrylates can be selected from, for example, C₁-C₂₀ linear alkyl, C₃-C₂₀ branched alkyl, C₃-C₂₀ cycloalkyl, C₃-C₂₀ fused ring polycycloalkyl, C₅-C₂₀ aryl, and C₁₀-C₂₀ fused ring aryl.

Examples of C₁-C₂₀ (meth)acrylates (that are free of carbonyl groups that are reactive with the hydrazide groups of the hydrazide functional material) from which the (meth)acrylate polymer of the first carbonyl-functional component is prepared include, but are not limited to, methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, 2-ethylhexyl (meth)acrylate, lauryl (meth)acrylate, isobornyl (meth)acrylate, cyclohexyl (meth)acrylate and 3,3,5-trimethylcyclohexyl (meth)acrylate.

The (meth)acrylate polymer having at least two carbonyl groups is prepared from ethylenically unsaturated radically polymerizable monomers having one or more carbonyl groups that are reactive with the hydrazide groups of the hydrazide functional material. A class of ethylenically unsaturated radically polymerizable monomers, having one or more carbonyl groups that are reactive with the hydrazide groups of the hydrazide functional material, include but are not limited to, carbonyl functional (meth)acrylamide monomers, such as ketone functional (meth)acrylamide monomers and aldehyde functional (meth)acrylamide monomers. A non-limiting example of a carbonyl functional (meth)acrylamide monomer is N-(2-methyl-4-oxopentan-2-yl)acrylamide, which is also referred to as diacetoneacrylamide. Further examples of ethylenically unsaturated radically polymerizable monomers, having one or more carbonyl groups that are reactive with the hydrazide groups of the hydrazide functional material, include but are not limited to: acetoacetoxyethyl (meth)acrylate; vinyl acetoacetate; 2-propenoic acid, 3-oxobutyl ester; 2-propenoic acid, 3-oxopentyl ester; 2-propenoic acid, 2-methyl-, 3-oxobutyl ester; 2-propenoic acid, 3-oxoheptyl ester; 2-propenoic acid, 5-methoxy-3-oxopentyl ester; 2-propenoic acid, 2-methyl-, 1-methyl-3-oxobutyl ester; 2-propenoic acid, 4-methyl-3-oxopentyl ester; butanoic acid, 3-oxo-, anhydride with 2-propenoic acid; benzoic acid, 4-ethenyl-, 3-oxobutyl ester; 2-propenoic acid, 1-methyl-1-(4-methyl-2-oxocyclohexyl)ethyl ester; 10-undecen-2-one, 1,1,1-trifluoro-; ethanone, 2,2,2-trifluoro-1-[2-(4-pentenyl)phenyl]- (9CI); and combinations of two or more thereof.

Classes of ethylenically unsaturated radically polymerizable monomers, other than (meth)acrylates, that are free of carbonyl groups that are reactive with the hydrazide groups of the hydrazide functional material, include but are not limited to: vinyl aromatic monomers; vinyl esters of carboxylic acids; allylic monomers; C₂-C₂₄ olefins; and combinations thereof. Examples of ethylenically unsaturated radically polymerizable monomers, other than (meth)acrylates, that are free of carbonyl groups that are reactive with the hydrazide groups of the hydrazide functional material, include but are not limited to: vinyl alcohol; vinyl chloride; acrylonitrile; trimethyl(4-methyl-4-penten-1-yl)-silane; 1-octene; 1-undecene; 1-octadecene; 4-heptenal; 5-methyl 1-heptene; ethenyl cyclopentane; bicyclo[2.2.1]hept-2-ene; ethenyl cyclohexane; 2-propenoic acid, cyclohexyl ester; 2-propenoic acid, bicyclo[2.2.1]hept-2-yl ester; 2-propenoic acid, 4-(1,1-dimethylethyl)cyclohexyl ester; 2-propenoic acid, tricyclo[3.3.1.13,7]dec-2-yl ester; styrene; p-chloromethylstyrene; divinyl benzene; vinyl naphthalene; divinyl naphthalene; vinyl acetate; vinyl butyrate; vinyl 3,4-dimethoxybenzoate; vinyl benzoate; allyl chloride; allyl acetate, allyl alcohol, allyl benzyl ether, allyl phenyl ether, 3-allyloxy-1,2-propanediol, allyl methyl ether, and combinations of two or more thereof.

With some embodiments, the (meth)acrylate polymer having at least two carbonyl groups that are reactive with hydrazide groups, can be prepared by first forming a hydroxyl functional (meth)acrylate polymer intermediate, using monomers including hydroxyl functional (meth)acrylate monomers and/or hydroxyl functional ethylenically unsaturated radically polymerizable monomers. The hydroxyl functional (meth)acrylate polymer intermediate is then reacted with a carbonyl functional carboxylic acid ester under art-recognized transesterification conditions, which results in the formation of a (meth)acrylate polymer having at least two carbonyl groups that are reactive with hydrazide groups.

The first carbonyl-functional component includes, with some embodiments, at least two ketone groups. In accordance with some embodiments, the (meth)acrylate polymer of the first carbonyl-functional component includes ketone functional (meth)acrylamide monomer residues (or monomer units). In accordance with some further embodiments, the (meth)acrylate polymer of the first carbonyl-functional component includes N-(2-methyl-4-oxopentan-2-yl)acrylamide monomer residues (or monomer units).

The (meth)acrylate polymer of the first carbonyl-functional component has, with some embodiments, a carbonyl equivalent weight of from 165 g/mole to 550 g/mole, or from 200 g/mole to 450 g/mole, or from 250 g/mole to 400 g/mole. With some further embodiments, the (meth)acrylate polymer of the first carbonyl-functional component has a Mw of from 1000 g/mole to 10,000 g/mole, or from 3000 g/mole to 9000 g/mole, or from 5000 g/mole to 9000 g/mole, as measured in THE solvent.

The (meth)acrylate polymer of the first carbonyl-functional component has at least two carbonyl groups, which are in each case independently selected from ketone groups and aldehyde groups. With some embodiments, the (meth)acrylate polymer of the first carbonyl-functional component has 2 to 30 carbonyl groups, or 5 to 30 carbonyl groups, or 10 to 25 carbonyl groups (which are in each case independently selected from ketone groups and aldehyde groups).

The curable photochromic composition optionally includes a second carbonyl-functional component including at least one carbonyl group that is reactive with hydrazide groups. The second carbonyl-functional component includes at least one of polycarbonate carbonyl, polyester carbonyl, polyether carbonyl, polyurethane carbonyl, or combinations of two or more thereof. Each carbonyl group of the second carbonyl-functional component is in each case independently selected from ketone groups and aldehyde groups. The second carbonyl-functional component, with some embodiments, is not and does not include a (meth)acrylate polymer having at least one carbonyl group.

The polycarbonate carbonyl of the second carbonyl-functional component can be prepared in accordance with art-recognized methods. With some embodiments, and for purposes of non-limiting illustration, the polycarbonate carbonyl can be prepared from the reaction of an aliphatic polyol, such as a diol, with a carbonyl dihalide, such as carbonyl dichloride, with removal of the resulting halide acid, such as HCl. For purposes of further non-limiting illustration, the polycarbonate carbonyl can be prepared from a transesterification reaction of a polyol, such as a diol, and a dihydrocarbyl carbonate, such as diphenyl carbonate, with removal of the resulting hydroxyl functional hydrocarbyl, such as phenol.

With some embodiments, preparation of the polycarbonate carbonyl involves first forming a hydroxyl terminated polycarbonate intermediate. The hydroxyl terminated polycarbonate intermediate is then reacted with: a carbonyl functional carboxylic acid, such as an oxoalkenoic acid, such as 4-oxopentanoic acid (levulinic acid), or 4-acetylbenzoic acid; or a carbonyl functional carboxylic acid ester, such as an oxoalkenoic acid ester, such as ethyl 4-oxopentanoate (ethyl levulinate), or ethyl acetoacetate, which results in the formation of the polycarbonate carbonyl, having at least one carbonyl group (such as a ketone group) that is reactive with hydrazide groups.

Examples of polyols having at least two hydroxyl groups, from which the polycarbonate carbonyl can be prepared, include, but are not limited to, glycerin, trimethylolpropane, trimethylolethane, trishydroxyethylisocyanurate, pentaerythritol, ethylene glycol, propylene glycol, trimethylene glycol, 1,3-, 1,2- and 1,4-butanediols, pentane diols (such as, but not limited to, 1,5-pentane diol), heptanediol, hexanediol, octanediol, 4,4′-(propane-2,2-diyl)dicyclohexanol, 4,4′-methylenedicyclohexanol, neopentyl glycol, 2,2,3-trimethylpentane-1,3-diol, 1,4-dimethylolcyclohexane, 2,2,4-trimethylpentane diol, and like polyols.

With some embodiments, the polycarbonate carbonyl is prepared from commercially available polycarbonate polyols, such as, but not limited to: ETERNACOLL© polycarbonate diols from UBE Industries, Ltd.; and DURANOL polycarbonate diols from Asahi Kasei.

The polyester carbonyl of the second carbonyl-functional component can be prepared in accordance with art-recognized methods. With some embodiments, and for purposes of non-limiting illustration, the polyester carbonyl can be prepared by reacting aliphatic carboxylic acid functional materials (and/or cyclic anhydrides thereof, and/or esters thereof) having carboxylic acid functionalities (or effective carboxylic acid functionalities, such as in the case of cyclic anhydrides and carboxylic acid esters) of at least 2, and polyols having hydroxy functionalities of at least 2. The molar equivalents ratio of carboxylic acid groups to hydroxy groups of the reactants is selected so as to provide a polyester intermediate having hydroxyl functionality and/or carboxylic acid functionality, and a desired molecular weight.

Examples of multifunctional carboxylic acids useful in preparing the polyester carbonyls include, but are not limited to, tetrahydrophthalic acid, hexahydrophthalic acid, endobicyclo-2,2,1,5-heptyne-2,3-dicarboxylic acid, cyclohexanedioic acid, succinic acid, azelaic acid, maleic acid, adipic acid, sebacic acid, and like multifunctional carboxylic acids (optionally including appropriate cyclic anhydrides thereof and/or esters thereof).

Examples of polyols that can be used to prepare each polyester carbonyl of the second carbonyl-functional component include, but are not limited to, those polyol examples recited previously herein.

With some embodiments, preparation of the polyester carbonyl involves first forming a hydroxyl terminated polyester intermediate. The hydroxyl terminated polyester intermediate is then reacted with: a carbonyl functional carboxylic acid, such as an oxoalkenoic acid, such as 4-oxopentanoic acid (levulinic acid), or 4-acetylbenzoic acid; or a carbonyl functional carboxylic acid ester, such as an oxoalkenoic acid ester, such as ethyl 4-oxopentanoate (ethyl levulinate), or ethylacetoacetate, which results in the formation of the polyester carbonyl, having at least one carbonyl group (such as a ketone group) that is reactive with hydrazide groups.

The polyester carbonyl, with some embodiments, can be prepared using one or more commercially available hydroxyl functional polyesters as an intermediate, which is reacted with a carbonyl functional carboxylic acid, such as those examples described above. Examples of commercially available hydroxyl functional polyesters that can be used as such an intermediate include, but are not limited to those commercially available from: Stepan Company, such as, STEPANOL PC polyester polyols; DIC Corporation, such as OD-X-286, OD-X-102, OD-X-355, OD-X-2330, OD-X-240, OD-X-668, OD-X-21068, OD-X-2547, OD-X-2420, OD-X-2523, OD-X-2555, and OD-X-2560 polyester polyols, OD-X-2155 and OD-X-640 polycaprolactone diols, and OD-X-2586 triol; TRiiSO, such as PERSTORP BOLTORN H2004 hyper branched polyester polyols; INGEVITY, such as CAPA polycaprolactone polyols; BASF, such as LUPRAPHEN polyester polyols; Evonik Industries, such as DYNACOLL polyester polyols; and Bayer, such as DESMOPHEN polyester polyols, and BAYCOLL polyester polyols.

The polyether carbonyl of the second carbonyl-functional component can be prepared in accordance with art-recognized methods. With some embodiments, the polyether carbonyl is prepared from hydroxyl functional polyethers (or polyether polyols), such as polyalkylene glycols, such as, but not limited to, polyethylene glycol, polypropylene glycol, poly(1,2-butylene glycol), polyethylene glycol-polypropylene glycol copolymer, and polytetrahydrofuran. Examples of commercially available hydroxyl functional polyethers, which can be used to prepare the polyether carbonyl, include, but are not limited to, those commercially available from: Dow Chemicals, such as VORANOL polyether polyols; BASF, such as LUPRANOL, PLURACOL, PLURONIC, and PolyTHF polyether polyols; and Bayer, such as DESMOPHEN and ACCLAIM polyether polyols. The hydroxyl functional polyether (or hydroxyl functional polyether intermediate) is, with some embodiments, reacted with: a carbonyl functional carboxylic acid, such as an oxoalkenoic acid, such as 4-oxopentanoic acid (levulinic acid), or 4-acetylbenzoic acid; or a carbonyl functional carboxylic acid ester, such as an oxoalkenoic acid ester, such as ethyl 4-oxopentanoate (ethyl levulinate), or ethyl acetoacetate, which results in the formation of the polyether carbonyl, having at least one carbonyl group (such as a ketone group) that is reactive with hydrazide groups.

The polyurethane carbonyl of the second carbonyl-functional component can be prepared in accordance with art-recognized methods. With some embodiments, and for purposes of non-limiting illustration, the polyurethane carbonyl can be prepared from the reaction of a polyisocyanate having at least two isocyanate groups, with a polyol having at least two hydroxy groups, with: an appropriate molar excess of hydroxyl groups, so as to form a hydroxyl functional polyurethane intermediate having at least 2 hydroxyl groups; or an appropriate molar excess of isocyanate groups so as to form a polyurethane intermediate having at least 2 isocyanate groups. Examples of polyisocyanates useful in the preparation of polyurethane carbonyl include, with some embodiments, aliphatic, cycloaliphatic and heterocyclic polyisocyanates, and mixtures of such polyisocyanates.

Further examples of polyisocyanates useful in the preparation of polyurethane carbonyl include, but are not limited to, tetramethylene-1,4-diisocyanate; hexamethylene-1,6-diisocyanate; 2,2,4-trimethyl hexane-1,6-diisocyanate; 2,4,4-trimethyl hexane-1,6-diisocyanate; lysine methyl ester diisocyanate; bis(isocyanato ethyl)fumarate; isophorone diisocyanate; ethylene diisocyanate; dodecane-1,12-diisocyanate; cyclobutane-1,3-diisocyanate; cyclohexane-1,3-diisocyanate; cyclohexane-1,4-diisocyanate; methyl cyclohexyl diisocyanate; hexahydrotoluene-2,4-diisocyanate; hexahydrotoluene-2,6-diisocyanate; hexahydrophenylene-1,3-diisocyanate; hexahydrophenylene-1,4-diisocyanate; perhydrodiphenylmethane-2,4′-diisocyanate; perhydrodiphenylmethane-4,4′-diisocyanate; norbornane diisocyanate; and mixtures thereof.

Examples of polyols having at least two hydroxyl groups, from which the polyurethane carbonyl of the second carbonyl-functional component can be prepared, include, but are not limited to those polyols recited previously herein.

With some embodiments, the polyurethane carbonyl of the second carbonyl-functional component, is prepared from the reaction of a hydroxy functional polyurethane intermediate and: a carbonyl functional carboxylic acid, such as an oxoalkenoic acid, such as 4-oxopentanoic acid (levulinic acid), or 4-acetylbenzoic acid; or a carbonyl functional carboxylic acid ester, such as an oxoalkenoic acid ester, such as ethyl 4-oxopentanoate (ethyl levulinate), or ethyl acetoacetate, which results in the formation of the polyurethane carbonyl, having at least one carbonyl group (such as a ketone group) that is reactive with hydrazide groups.

The polyurethane carbonyl of the second carbonyl-functional component, with some embodiments, is prepared from a commercially available hydroxy functional polyurethane intermediate, such as a commercially available hydroxy functional thermoplastic polyurethane intermediate. Examples of commercially available hydroxy functional polyurethanes include, but are not limited to those commercially available from: Lubrizol, such as PEARLSTICK, PEARLBOND, ESTANE, TECOFLEX, and CARBOTHANE hydroxyl functional polyurethanes; AdvanSource Biomaterials Corporation, such as CHRONOFLEX AL, CHRONOFLEX C, CHRONOTHANE P, and CHRONOSIL hydroxyl functional polyurethanes; AorTech International Plc, such as ELAST-EON hydroxyl functional polyurethanes; and Biometrics, such as QUADRATHANE hydroxyl functional polyurethanes.

With some further embodiments, the polyurethane carbonyl of the second carbonyl-functional component, is prepared from the reaction of an isocyanate functional polyurethane intermediate and a hydroxyl functional carbonyl compound, such as a hydroxyalkan-2-one, such as 5-hydroxypentan-2-one, which results in the formation of the polyurethane carbonyl, having at least one carbonyl group (such as a ketone group) that is reactive with hydrazide groups.

The second carbonyl-functional component of the curable photochromic composition, with some embodiments, has an equivalent weight of from 580 g/mole to 10,000 g/mole, or from 800 g/mole to 8000 g/mole, or from 1000 g/mole to 5000 g/mole. With some further embodiments, the second carbonyl-functional component has a Mw of from 580 g/mole to 40,000 g/mole, or from 1000 g/mole to 30,000 g/mole, or from 2000 g/mole to 15,000 g/mole.

The second carbonyl-functional component includes at least one carbonyl group, which is in each case independently selected from ketone groups and aldehyde groups. With some embodiments, the second carbonyl-functional component includes 1 to 20 carbonyl groups, or 1 to 10 carbonyl groups, or 1 to 8 carbonyl groups (which are in each case independently selected from ketone groups and aldehyde groups).

In accordance with some embodiments of the present invention, the first carbonyl-functional component includes at least two ketone groups, and the second carbonyl-functional component includes at least one ketone group.

The curable photochromic composition of the present invention optionally includes a non-reactive component that is free of functional groups that are reactive with: the hydrazide functional material; the first carbonyl-functional component; and the second carbonyl-functional component. At least one of, (d1) the second carbonyl-functional component and/or (d2) the non-reactive component, are present in the curable photochromic composition of the present invention. In accordance with some embodiments of the curable photochromic compositions of the present invention, the second carbonyl-functional component is present, and the non-reactive component is optionally present.

The non-reactive component, with some embodiments, includes at least one of polyethers, polyesters, polycarbonates, polyurethanes, and/or organo phosphates. In further accordance with the present invention, the non-reactive component includes at least one of aliphatic polyethers, aliphatic polyesters, aliphatic polycarbonates, aliphatic polyurethanes, and/or organo phosphates. In accordance with some embodiments, the polyethers, polyesters, polycarbonates, and polyurethanes from which the non-reactive component can be selected, each independently have an Mn of 300 g/mole to 10,000 g/mole, or from 300 g/mole to 8000 g/mole, or from 400 g/mole to 6000 g/mole.

The polyethers of the non-reactive component include a plurality of ether linkages (—O—), and are free of aromatic groups in the case of aliphatic polyethers. With some embodiments, the polyether is an aliphatic polyether and includes a linear or branched C₁-C₂₀ alkyl linkage and/or a C₃-C₁₀ cycloalkyl linkage, independently between and/or extending from each ether linkage. The polyether of the non-reactive component, with some embodiments has terminal —OR^{a} groups, where R^{a} in each case is independently hydrogen (H), a linear or branched C₁-C₂₀ alkyl group, or a C₃-C₁₀ cycloalkyl group. With some additional embodiments, the polyether of the non-reactive component has terminal carboxylic acid ester groups, such as terminal —OC(O)R^{a} groups, where R^{a} in each case is independently a linear or branched C₁-C₂₀ alkyl group or a C₃-C₁₀ cycloalkyl group. The polyether of the non-reactive component, with some further embodiments has terminal urethane groups, such as terminal —OC(O)NHR^{a} groups, where R^{a} in each case is independently a linear or branched C₁-C₂₀ alkyl group or a C₃-C₁₀ cycloalkyl group.

The polyesters of the non-reactive component include a plurality of carboxylic acid ester linkages (—C(O)—O—), and are free of aromatic groups in the case of aliphatic polyesters. With some embodiments, the polyester of the non-reactive component is an aliphatic polyester and includes a linear or branched C₁-C₂₀ alkyl linkage and/or a C₃-C₁₀ cycloalkyl linkage, independently between and/or extending from each carboxylic acid ester linkage. With some additional embodiments, the polyester of the non-reactive component has terminal carboxylic acid ester groups, such as terminal —OC(O)R^{a} groups and/or terminal —C(O)OR^{a} groups, where R^{a} in each case is independently a linear or branched C₁-C₂₀ alkyl group or a C₃-C₁₀ cycloalkyl group. The polyester of the non-reactive component, with some additional embodiments has terminal urethane groups, such as terminal —OC(O)NHR^{a} groups, where R^{a} in each case is independently a linear or branched C₁-C₂₀ alkyl group or a C₃-C₁₀ cycloalkyl group.

The polycarbonates of the non-reactive component include a plurality of carbonate linkages (—O—C(O)—O—), and are free of aromatic groups in the case of aliphatic polycarbonates. With some embodiments, the polycarbonate of the non-reactive component is an aliphatic polycarbonate and includes a linear or branched C₁-C₂₀ alkyl linkage and/or a C₃-C₁₀ cycloalkyl linkage, independently between and/or extending from each carbonate linkage. With some additional embodiments, the polycarbonate of the non-reactive component has terminal carbonate groups, such as terminal —O—C(O)—O—R^{a} groups, where R^{a} in each case is independently a linear or branched C₁-C₂₀ alkyl group or a C₃-C₁₀ cycloalkyl group. The polycarbonate of the non-reactive component, with some additional embodiments has terminal urethane groups, such as terminal —OC(O)NHR^{a} groups, where R^{a} in each case is independently a linear or branched C₁-C₂₀ alkyl group or a C₃-C₁₀ cycloalkyl group.

The polyurethanes of the non-reactive component include a plurality of urethane linkages (—O—C(O)—N(H)—), and are free of aromatic groups in the case of aliphatic polyurethanes. With some embodiments, the polyurethane of the non-reactive component is an aliphatic polyurethane and includes a linear or branched C₁-C₂₀ alkyl linkage and/or a C₃-C₁₀ cycloalkyl linkage, independently between and/or extending from each urethane linkage. With some additional embodiments, the polyurethane of the non-reactive component has terminal urethane groups, such as terminal —N(H)—C(O)—OR^{a} groups and/or terminal —OC(O)NHR^{a} groups, where R^{a} in each case is independently a linear or branched C₁-C₂₀ alkyl group or a C₃-C₁₀ cycloalkyl group.

The organo phosphates from which the non-reactive component can be selected, with some embodiments, are represented by the following Formula (II),

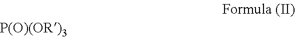

With reference to Formula (II), each R′ is in each case independently selected from alkyl, haloalkyl, perhaloalkyl, cycloalkyl, heterocycloalkyl, aryl, heteroaryl, and combinations thereof (including those classes and examples thereof as recited previously herein). With some further embodiments, each R′ of Formula (II) is in each case independently selected from alkyl, cycloalkyl, aryl, and combinations thereof. With further reference to Formula (II), and in accordance with some further embodiments, each R′ is in each case independently selected from C₁-C₂₀ linear alkyl, C₃-C₂₀ branched alkyl, C₃-C₂₀ cycloalkyl, C₅-C₂₀ aryl, and combinations thereof. With additional reference to Formula (II), and in accordance with some additional embodiments, each R′ is in each case independently selected from: phenyl; phenyl substituted with at least one of C₁-C₂₀ linear alkyl, C₃-C₂₀ branched alkyl, and C₃-C₂₀ cycloalkyl; C₁-C₂₀ linear alkyl substituted with at least one phenyl; C₃-C₂₀ branched alkyl substituted with at least one phenyl; and C₃-C₂₀ cycloalkyl substituted with at least one phenyl. Non-limiting examples of organo phosphates, from which the non-reactive component can be selected include, tricresyl phosphate, tris(2-phenylethyl) phosphate, tris(2-chloroethyl) phosphate, tris(1,3-dichloro-2-propyl)phosphate, cresyl diphenyl phosphate, tris(2,3-dibromopropyl)phosphate, tris-(2-ethylhexyl)phosphate, and tris(2-methylphenyl)phosphate.

The non-reactive component of the curable photochromic compositions of the present invention, with some embodiments, has a viscosity (at 25° C.) of from 1 cP to 60,000 cP, or from 1 cP to 10,000 cP, or from 1 cP to 7500 cP. The viscosity of the non-reactive component can be measured in accordance with art-recognized methods. With some embodiments, viscosity is measured using a rotation viscometer such as a Brookfield CAP 2000+ viscometer, available from AMETEK, Inc., according to the manufacturer's instructions. Additional methods of measuring viscosity include, but are not limited to, those as described in ASTM D789, or ASTM D4878.

With some embodiments, the non-reactive component is selected from a polymeric non-reactive component, such as an amorphous polymeric non-reactive component, and/or a crystalline non-reactive component.

In accordance with some further embodiments, the non-reactive component of the curable photochromic compositions of the present invention has a Tg of less than 50° C., or less than 30° C., or less than 10° C., when the non-reactive component is an amorphous polymeric non-reactive component. The non-reactive component of the curable photochromic compositions of the present invention, with some further embodiments, has a melting point of less than 50° C., or less than 30° C., or less than 10° C., when the non-reactive component is a crystalline non-reactive component.

With some embodiments, the Tg of the non-reactive component is measured in accordance with art-recognized methods, such as with Differential Scanning Calorimetry (DSC) at a heating rate of 2° C./minute. The melting point of the non-reactive component, with some embodiments, is determined in accordance with art-recognized methods, such as with DSC or in accordance with capillary tube methods or an optical microscope with heating stage.

With some embodiments of the curable photochromic composition of the present invention, the second carbonyl-functional component and the non-reactive component are present in a combined amount of from 10 percent by weight to 50 percent by weight, or from 15 percent by weight to 45 percent by weight, or from 20 percent by weight to 40 percent by weight, where the percent weights are in each case based on total resin solids of the curable photochromic composition.

As used herein, and with regard to the curable photochromic composition, the term “total weight of resin solids” and similar terms, such as “total resin solids weight” and “total resin solids” means the total weight of the hydrazide functional material, the first carbonyl-functional component, the second carbonyl-functional component, and the non-reactive component, and with some further embodiments, does not include the weight of the photochromic compound(s) or other optional additives.

The curable photochromic compositions of the present invention include a photochromic compound(s). The photochromic compound can be selected from known classes and examples of photochromic compounds, and can include combinations or mixtures thereof.

For example, although not limiting herein, mixtures of photochromic compounds can be used to attain certain activated colors, such as a near neutral gray or near neutral brown. See, for example, U.S. Pat. No. 5,645,767, col. 12, line 66 to col. 13, line 19, which describes the parameters that define neutral gray and brown colors, which disclosure is specifically incorporated by reference herein.

With some embodiments, the photochromic compound, of the curable photochromic compositions of the present invention, is selected from the group consisting of naphthopyrans, benzopyrans, phenanthropyrans, indenonaphthopyrans, spiro(indoline)naphthoxazines, spiro(indoline)pyridobenzoxazines, spiro(benzindoline)pyridobenzoxazines, spiro(benzindoline)naphthoxazines, spiro(indoline)-benzoxazines, fulgides, fulgimides, diarylethenes, and mixtures of such photochromic compounds.

Further examples of other photochromic compounds that can be used in curable photochromic compositions of the present invention include, but are not limited to, those disclosed at column 34, line 20 through column 35, line 13 of U.S. Pat. No. 9,028,728 B2, which disclosure is specifically incorporated by reference herein.

The photochromic compound is present in the curable photochromic compositions of the present invention in an amount at least sufficient so as to provide an article prepared from the composition with a desirable level of photochromic properties, which in some embodiments is referred to as a photochromic amount. With some embodiments, the amount of photochromic compound(s) present in the curable photochromic composition is from 0.001 percent by weight to 40 percent by weight, or from 0.001 to 10 percent by weight, or from 0.01 to 5 percent by weight, or from 0.1 to 2.5 percent by weight, where the percent by weights are in each case based on the total resin solids weight.

The curable photochromic compositions of the present invention can, with some embodiments, optionally include additives such as, but not limited to: waxes, such as for flow and wetting; flow control agents, such as poly(2-ethylhexyl)acrylate; antioxidants; and ultraviolet (UV) light absorbers. Examples of useful antioxidants and UV light absorbers include, but are not limited to, those available commercially from BASF under the trademarks IRGANOX and TINUVIN. A non-limiting class of antioxidants are hindered amine light stabilizers (HALS), which can include one or more 2,2,6,6-tetralkylpiperindin-4-yl groups, such as one or more 2,2,6,6-tetramethylpiperidin-4-yl groups. These optional additives, when used, can be present in amounts up to 20 percent by weight, based on total resin solids weight.

The curable photochromic compositions of the present invention can, with some embodiments, further include one or more fixed-tint dyes. As used herein, the term “fixed-tint dye” and related terms, such as “fixed-colorant,” “static colorant,” “fixed dye,” and “static dye” means dyes that are: non-photosensitive materials, which do not physically or chemically respond to electromagnetic radiation with regard to the visually observed color thereof. The term “fixed-tint dye” and related terms as used herein does not include and is distinguishable from photochromic compound. As used herein, the term “non-photosensitive materials” means materials that do not physically or chemically respond to electromagnetic radiation with regard to the visually observed color thereof, including, but not limited to, fixed-tint dyes.

One or more fixed-tint dyes can be present in the curable photochromic compositions of the present invention for purposes including, but not limited to, providing a cured article prepared from the curable photochromic compositions with: at least a base (or first) color characteristic of the fixed-tint dye, when the photochromic compound is not activated; and optionally a second color characteristic of the combination of the fixed-tint dye and the photochromic compound when activated, such as by exposure to actinic radiation.

The optional fixed-tint dye of the curable photochromic composition, with some embodiments, includes at least one of azo dyes, anthraquinone dyes, xanthene dyes, azime dyes, iodine, iodide salts, polyazo dyes, stilbene dyes, pyrazolone dyes, triphenylmethane dyes, quinoline dyes, oxazine dyes, thiazine dyes, and polyene dyes.

The fixed-tint dye can be present in the curable photochromic composition in varying amounts to provide the intended effect in the cured article prepared therefrom. With some embodiments, the fixed-tint dye is present in the curable photochromic composition in an amount of from 0.001 to 15 percent by weight, or from 0.01 to 10 percent by weight, or from 0.1 to 2.5 percent by weight, the percent weights in each case being based on the total resin solids weight of the curable photochromic composition.

The curable photochromic compositions of the present can, with some embodiments, include one or more solvents, selected from water, organic solvents, and combinations thereof.

Classes of organic solvents that can be present in the curable photochromic compositions of the present invention include, but are not limited to: alcohols, such as, methanol, ethanol, n-propanol, iso-propanol, n-butanol, sec-butyl alcohol, tert-butyl alcohol, iso-butyl alcohol, furfuryl alcohol and tetrahydrofurfuryl alcohol; ethers, such as, dimethyl ether and methyl ethyl ether; cyclic ethers, such as, tetrahydrofuran and dioxane; esters, such as, ethyl acetate, ethyl lactate, ethylene carbonate and propylene carbonate; hydroxy functional ethers of alkylene glycols, such as, butyl-2-hydroxyethyl ether, methy-1,2-hydroxypropyl ether and phenyl-2-hydroxypropyl ether; nitrogen containing cyclic compounds, such as, pyrrolidone, N-methyl-2-pyrrolidone, 1-butyl-pyrrolidinone, and 1,3-dimethyl-2-imidazolidinone; sulfur containing compounds, such as, dimethyl sulfoxide and tetramethylene sulfone; aromatic compounds, such as, toluene, xylene, anisole, and butyl benzoate; and mixtures of aromatic compounds, such as, but not limited to, Aromatic 100 Fluid, which is a commercially available mixture of C₉-C₁₀ dialkyl- and trialkyl-benzenes, and Aromatic 150 Fluid, which is a commercially available mixture of C₁₀-C₁₂ alkylbenzenes and alkylnaphthalenes.

Solvent(s) can be present in the curable photochromic compositions of the present invention, in an amount of from 5 to 95 percent by weight, or from 15 to 80 percent by weight, from 30 to 70 percent by weight, or from 30 to 60 percent by weight, in each case based on the total weight of the curable photochromic composition (including the weight of the solvent).

The present invention also relates to articles, and in particular, photochromic articles that are prepared from the curable photochromic composition of the present invention as described previously herein. With some embodiments, the photochromic article is selected from layers (including films and/or sheets), and 3-dimensional articles.

Classes of 3-dimensional articles, that can be prepared from the curable photochromic compositions of the present invention, include, but are not limited to, ophthalmic articles, display articles, windows, and mirrors.

More typically, the curable photochromic compositions of the present invention are used to prepare photochromic layers, such as photochromic films and photochromic sheets. As used herein, the term “film” means a layer that is not self-supporting, such as, but not limited to, a coating. As used herein, the term “sheet” means a layer that is self-supporting, such as, but not limited to, an extruded sheet.

The curable photochromic composition of the present invention can be cured by any suitable methods that result in the formation of covalent bonds between hydrazide groups of the hydrazide functional material and carbonyl groups of the first carbonyl-functional component and optional second carbonyl-functional component. With some embodiments, the curable photochromic composition is cured by exposure to elevated temperature (in excess of ambient room temperature, such as above 25° C.). As used herein, by “cured” is meant a three dimensional crosslink network is formed by covalent bond formation, such as hydrazone linkages or units, resulting from reaction between hydrazide groups of the hydrazide functional material and carbonyl groups of the first carbonyl-functional component and optional second carbonyl-functional component. When cured at elevated temperature, the curable photochromic composition can be referred to herein as a thermosetting curable photochromic composition. The temperature at which the thermosetting curable photochromic composition of the present invention is cured is variable and depends in part on the amount of time during which curing is conducted. With some embodiments, the curable photochromic composition is cured at an elevated temperature of from 60° C. to 175° C., or from 65° C. to 150° C., or from 70° C. to 130° C., for a period of 15 to 240 minutes.

The present invention also relates to an article, such as a photochromic article, that comprises: (A) a substrate; and (B) a photochromic layer over at least one surface of the substrate, wherein the photochromic layer is formed from the curable photochromic composition of the present invention.

The article, that includes a substrate, and a photochromic layer over at least one surface of the substrate (formed from the curable photochromic composition of the present invention) can, with some embodiments, be selected from ophthalmic articles, display articles, windows, and mirrors. Correspondingly, the substrate of the article can be selected from ophthalmic substrates, displays, windows, and mirrors. The substrate can be composed of one or more suitable materials, including, but not limited to: organic materials, such as organic polymeric materials, such as, but not limited to, thermoplastic polycarbonates, crosslinked polycarbonates, poly(meth)acrylates, and combinations thereof; glasses, such as silica-based glasses; metals; ceramic materials; and combinations thereof. Examples of substrates that can be included in the article (including optical elements) of the present invention include, but are not limited to, those described at column 35, line 5 through column 36, line 57 of U.S. Pat. No. 8,628,685 B2, which disclosure is incorporated herein by reference.

The substrate, with some embodiments, can optionally include a photochromic material and/or a fixed-tint dye, which can each be selected from those classes and examples of photochromic materials and fixed-tint dyes as described previously herein. The optional photochromic material(s)/compound(s) present in the substrate can be the same or different than the photochromic compound(s) of the photochromic layer. The optional fixed-tint dye(s) can be the same or different than the optional fixed-tint dye(s) of the photochromic layer.

The photochromic layer of the article can be a photochromic film or a photochromic sheet. With some embodiments, the photochromic film of the article is a photochromic coating, and the curable photochromic composition of the present invention is a curable photochromic coating composition.

The curable photochromic coating composition can be applied to the substrate in accordance with art-recognized methods, which include, but are not limited to, spray application methods, curtain coating application methods, draw-down blade (or bar) application methods, dip-coating application methods, spin-coating application methods, jet printing methods (such as inkjet printing methods, where the “ink” is replaced with a curable photochromic composition according to the present invention), and combinations thereof.

After application of the curable photochromic composition over at least one surface of the substrate, the applied curable photochromic composition is cured, such as described previously herein. The photochromic layer can be in the form of a single layer or multiple layers. When in the form of multiple layers, each layer of the photochromic layer can be prepared from curable photochromic compositions according to the present invention, having the same or different compositions, such as the same or different photochromic compound(s). The photochromic layer can have any suitable thickness, such as from 10 micrometers to 250 micrometers, or from 15 micrometers to 75 micrometers.

In addition to the photochromic layer, the article can optionally include one or more further art-recognized layers, such as, but not limited to: a primer layer(s); an adhesive layer(s); a protective layer(s) (such as a hard-coat layer); a polarizing layer(s); a birefringent layer(s); an antireflective layer(s); and/or another photochromic layer(s) that is prepared from a composition other than the curable photochromic composition of the present invention.

The present invention further relates to a photochromic multilayer article including at least one photochromic layer formed from the curable photochromic composition of the present invention. Each layer of the photochromic multilayer article can independently be in the form of a film or a sheet. The photochromic multilayer article can include, with some embodiments, two or more layers that are formed from the same or different curable photochromic compositions of the present invention.

The multilayer article of the present invention can optionally include one or more further art-recognized layers, such as, but not limited to: an adhesive layer(s); a protective layer(s) (such as a hard-coat layer); a polarizing layer(s); a birefringent layer(s); an antireflective layer(s); and/or another photochromic layer(s) that is prepared from a composition other than the curable photochromic composition of the present invention.

The multilayer article of the present invention can have any suitable thickness, such as from 10 micrometers to 1000 micrometers, or from 15 micrometers to 750 micrometers, or from 25 to 100 micrometers.

The multilayer article of the present invention can be used alone or in conjunction with another article, such as a substrate. The substrate can be selected from those classes and examples of substrates as described previously herein with regard to the article of the present invention, such as ophthalmic substrates, displays, windows, and/or mirrors. The substrate can be composed of one or more suitable materials, including, but not limited to: organic materials, such as organic polymeric materials; glasses, such as silica-based glasses; metals; ceramic materials; and combinations thereof.

The multilayer article of the present invention can be adhered to a surface of a substrate by art-recognized methods, such as, but not limited to: static clinging, such as with static electricity; one or more interposed adhesive layers; fusion bonding, such as thermal fusion bonding; and in-mold formation, such as where the multilayer article is placed in a mold, and the substrate is formed against at least one surface of the multilayer article within the mold. The multilayer article of the present invention can, with some embodiments, be supported by one or more brackets that engage retainingly with one or more peripheral regions of the multilayer article.

The present invention can be further characterized by one or more of the following non-limiting clauses.

Clause 1: A curable photochromic composition comprising:
(a) a photochromic compound;
(b) a hydrazide functional material comprising at least two hydrazide groups that are reactive with carbonyl groups selected from ketone groups and aldehyde groups;
(c) a first carbonyl-functional component comprising a (meth)acrylate polymer having at least two carbonyl groups that are reactive with hydrazide groups, wherein each carbonyl group of said first carbonyl-functional component is independently selected from ketone groups and aldehyde groups; and
(d) at least one of,
   (d1) a second carbonyl-functional component comprising at least one carbonyl group that is reactive with hydrazide groups, wherein said second carbonyl-functional component comprises at least one of polycarbonate carbonyl, polyester carbonyl, polyether carbonyl, polyurethane carbonyl, or combinations thereof, wherein each carbonyl group of said second carbonyl-functional component is independently selected from ketone groups and aldehyde groups; or
   (d2) a non-reactive component that is free of functional groups that are reactive with said hydrazide functional material, said first carbonyl-functional component, and said second carbonyl-functional component.

Clause 2: The curable photochromic composition of clause 1, wherein the hydrazide functional material has a hydrazide equivalent weight of from 250 g/mole to 10,000 g/mole, or from 300 g/mole to 8000 g/mole, or from 500 g/mole to 5000 g/mole.

Clause 3: The curable photochromic composition of clause 1 or clause 2, wherein the hydrazide functional material has a Mw of from 500 g/mole to 50,000 g/mole, or from 1000 g/mole to 40,000 g/mole, or from 2000 g/mole to 40,000 g/mole.

Clause 4: The curable photochromic composition of any one of clauses 1-3 wherein the hydrazide functional material comprises a polyurethane comprising at least two hydrazide groups that are reactive with carbonyl groups selected from ketone groups and aldehyde groups.

Clause 5: The curable photochromic composition of any one of clauses 1-4, wherein the hydrazide functional material comprises from 2 to 60 hydrazide groups, or from 2 to 55 hydrazide groups, or from 2 to 50 hydrazide groups, that are reactive with carbonyl groups selected from ketone groups and aldehyde groups.

Clause 6: The curable photochromic composition of any one of clauses 1-5, wherein at least some hydrazide groups of the hydrazide functional material are independently and reversibly blocked with an aldehyde having a formula weight of less than 250 g/mole, or from 44 g/mole to less than 250 g/mole.

Clause 7: The curable photochromic composition of any one of clauses 1-6, wherein at least some hydrazide groups of the hydrazide functional material are independently and reversibly blocked with or a ketone having a formula weight of less than 250 g/mole, or from 58 g/mole to less than 250 g/mole.

Clause 8: The curable photochromic composition of any one of clauses 1-7, wherein a ratio, of total carbonyl equivalents of the first carbonyl-functional component and the second carbonyl-functional component to total equivalents of hydrazide equivalents of the hydrazide functional material, is from 1:0.8 to 1:4, or from 1:0.8 to 1:3, or from 1:1 to 1:2.

Clause 9: The curable photochromic composition of any one of clauses 1-8, wherein the hydrazide functional component comprises at least one of a nonpolymeric hydrazide functional material and/or a polymeric hydrazide functional material.

Clause 10: The curable photochromic composition of any one of clauses 1-9, wherein the hydrazide functional component comprises a nonpolymeric hydrazide comprising at least one of: fumeric acid dihydrazide; maleic acid dihydrazide; itaconic acid dihydrazide; phthalic acid dihydrazide; terephthalic acid dihydrazide; trimellitic acid trihydrazide; oxalic acid dihydrazide; succinic acid dihydrazide; 2-methylsuccinic acid dihydrazide; adipic acid dihydrazide; sebacic acid dihydrazide; cyclohexane dicarboxylic acid dihydrazide; and cyclohexane tricarboxylic acid trihydrazide.

Clause 11: The curable photochromic composition of any one of clauses 1-10, wherein the hydrazide functional component comprises a hydrazide functional polymer, wherein the hydrazide functional polymer comprises a polymer backbone selected from polyethers, polyesters, polycarbonates, polyurethanes, and combinations of two or more thereof.

Clause 12: The curable photochromic composition of any one of clauses 1-11, wherein the hydrazide functional component comprises a hydrazide functional polymer that comprises one or more linking groups, wherein each linking group is in each case independently selected from: ether linkages (—O—); thioether linkages (—S—); urea linkages (—N(R)—C(O)—N(R)—); carbonate linkages (—O—C(O)—O—); carboxylic acid ester linkages (—O—C(O)—); urethane linkages (—N(H)—C(O)—O—); thiourethane linkages (—S—C(O)—N(H)—); thiourea linkages (—N(R)—C(S)—N(R)—); and amide linkages (—C(O)—N(R)—), wherein each R is in each case independently selected from hydrogen, alkyl, haloalkyl, perhaloalkyl, cycloalkyl, heterocycloalkyl, and combinations thereof.

Clause 13: The curable photochromic composition of any one of clauses 1-12, wherein the hydrazide functional component comprises a hydrazide functional polymer that is represented by the following Formula (I):

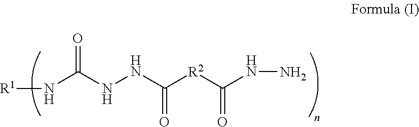

wherein, R¹ is a residue of a polymer, such as a polyether, polyester, polycarbonate, and/or polyurethane; R², independently for each n, is a linear or branched divalent alkane, such as a divalent linear or branched C₁-C₁₀ alkane, a divalent cycloalkane group, such as a divalent C₅-C₈ cycloalkane group, or a divalent aromatic group, such as a divalent C₆-C₁₀ aromatic group; and n is from 2 to 60, such as from 2 to 55, or from 2 to 40, from 2 to 30.

Clause 14: The curable photochromic composition of any one of clauses 1-13, wherein the first carbonyl-functional component comprises at least two ketone groups, and the second carbonyl-functional component comprises at least one ketone group.

Clause 15: The curable photochromic composition of any one of clauses 1-14, wherein the second carbonyl-functional component comprises at least one ketone group.

Clause 16: The curable photochromic composition of any one of clauses 1-15, wherein the (meth)acrylate polymer of the first carbonyl-functional component comprises ketone functional (meth)acrylamide monomer residues.

Clause 17: The curable photochromic composition of any one of clauses 1-16, wherein the (meth)acrylate polymer of the first carbonyl-functional component has a carbonyl equivalent weight of from 165 g/mole to 550 g/mole, or from 200 g/mole to 450 g/mole, or from 250 g/mole to 400 g/mole.

Clause 18: The curable photochromic composition of any one of clauses 1-17, wherein the (meth)acrylate polymer of the first carbonyl-functional component has a Mw of from 1000 g/mole to 10,000 g/mole, or from 3000 g/mole to 9000 g/mole, or from 5000 g/mole to 9000 g/mole.

Clause 19: The curable photochromic composition of any one of clauses 1-18, wherein the second carbonyl-functional component has an equivalent weight of from 580 g/mole to 10,000 g/mole, or from 800 g/mole to 8000 g/mole, or from 1000 g/mole to 5000 g/mole.

Clause 20: The curable photochromic composition of any one of clauses 1-19, wherein the second carbonyl-functional component has a Mw of from 580 g/mole to 40,000 g/mole, or from 1000 g/mole to 30,000 g/mole, or from 2000 g/mole to 15,000 g/mole.

Clause 21: The curable photochromic composition of any one of clauses 1-20, wherein the non-reactive component has a viscosity, at 25° C., of from 1 cP to 60,000 cP, or from 1 cP to 10,000 cP, or from 1 cP to 7500 cP.

Clause 22: The curable photochromic composition of any one of clauses 1-21, wherein the non-reactive component has, a Tg of less than 50° C., or less than 30° C., or less than 10° C., when the non-reactive component is an amorphous polymeric non-reactive component, or a melting point of less than 50° C., or less than 30° C., or less than 10° C., when the non-reactive component is a crystalline non-reactive component.

Clause 23: The curable photochromic composition of any one of clauses 1-22, wherein the non-reactive component comprises at least one of polyethers, polyesters, polycarbonates, polyurethanes, and/or organo phosphates.

Clause 24: The curable photochromic composition of any one of clauses 1-23, wherein the non-reactive component comprises at least one of polyethers, polyesters, polycarbonates, and/or polyurethanes, which in each case independently have an Mn of 300 to 10,000, or from 300 to 8000, or from 400 to 6000.

Clause 25: The curable photochromic composition of any one of clauses 1-23, wherein the non-reactive component comprises an organo phosphate represented by the following Formula (II),

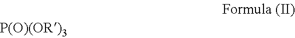

wherein R′ in each case is independently selected from alkyl, haloalkyl, perhaloalkyl, cycloalkyl, heterocycloalkyl, aryl, heteroaryl, and combinations thereof.

Clause 26: The curable photochromic composition of clause 25, wherein R′ in each case is independently selected from: phenyl; phenyl substituted with at least one of C₁-C₂₀ linear alkyl, and/or C₃-C₂₀ branched alkyl; C₁-C₂₀ linear alkyl substituted with at least one phenyl; and C₃-C₂₀ branched alkyl substituted with at least one phenyl.

Clause 27. The curable photochromic composition of any one of clauses 1-26, wherein the second carbonyl-functional component and the non-reactive component are present in a combined amount of from 10 percent by weight to 50 percent by weight, or from 15 percent by weight to 45 percent by weight, or from 20 percent by weight to 40 percent by weight, where the percent weights are in each case based on total resin solids of the curable photochromic composition.

Clause 28: The curable photochromic composition of any one of clauses 1-27, wherein the second carbonyl-functional component is present, and the non-reactive component is optionally present.

Clause 29: The curable photochromic composition of any one of clauses 1-28, wherein the photochromic compound (a) comprises at least one of naphthopyrans, benzopyrans, phenanthropyrans, indenonaphthopyrans, spiro(indoline)naphthoxazines, spiro(indoline)pyridobenzoxazines, spiro(benzindoline)pyridobenzoxazines, spiro(benzindoline)naphthoxazines, spiro(indoline)-benzoxazines, fulgides, diarylethenes, or fulgimides.

Clause 30: An article comprising:
(A) a substrate; and
(B) a photochromic layer over at least one surface of the substrate, wherein the photochromic layer is formed from the curable photochromic composition of any one of clauses 1-29.

The present invention is more particularly described in the following examples, which are intended to be illustrative only, since numerous modifications and variations therein will be apparent to those skilled in the art. Unless otherwise specified, all parts and all percentages are by weight.

### EXAMPLES

In Part 1 of the following examples, there is described the preparation of components used in the curable photochromic compositions of Part 2. In Part 2 of the following examples, there is described the preparation of comparative and inventive curable photochromic compositions. In Part 3 of the following examples, there is described the preparation of test specimens using the curable photochromic compositions of Part 2. In Part 4 of the following examples, there is described testing, and test results, of the test specimens of Part 4.

### Part 1

### Preparation Composition Components

### Example 1

### Preparation of Polyhydrazide.

Dipropylene glycol dimethyl ether (184.6 g), dimethylolpropionic acid (45.9 g), OXYMER™ HD-112 (88.9 g, an aliphatic polycarbonate diol with a molecular weight of 1000 g/mole, available from Perstorp), and isophorone diisocyanate (220 g) were added to a first reaction vessel equipped with a reflux condenser and nitrogen blanket and heated to 70° C. After the peak exotherm was observed, dibutyltin dilaurate (0.7 g) was added, and the reaction was held at 90° C. for 1 hour. Deionized water (925.3 g), dimethylethanolamine (27.3 g), and adipic dihydrazide (131.9 g) were added to a second reaction vessel equipped with a reflux condenser and nitrogen blanket, and heated to 35° C. Ninety percent by weight of the first mixture was added into the second vessel slowly to maintain a temperature lower than 45° C. The reaction mixture was held for 1 hour, then the volatiles were removed to yield 450 g of a white crystalline material. The white crystalline material had a Mw of 38,692 g/mole determined by GPC with polystyrene standards using Asahipak 510HQ column and DMF/LiBr solvent, and a theoretical hydrazide equivalent weight of 950 g/mole.

### Example 2

### Preparation of Acrylic Polyketone.

Di(propylene glycol)methyl ether acetate (60 ml) was sparged with N₂ for 15 minutes followed by heating to 130° C. To this was added a solution of diacetone acrylamide (89.2 g), n-butyl methacrylate (75 g), 2,2′-azobis(2-methylbutyronitrile) (9.75 g), triphenylphosphite (0.82 g), tert-dodecanethiol (1.65 g), dropwise over 60 minutes. After stirring for 30 min at 130° C., 2,2′-azobis(2-methylbutyronitrile) (0.5 g) in DPMA (5 ml) was added, the solution was stirred for an additional hour, cooled to 100° C., then slowly added to cold hexanes (5° C., 1.25 L) with stirring. The solution was then cooled to room temperature, after which the top layer was decanted off and the remaining viscous liquid was dried under vacuum at 50° C. for about two hours to give 175 g of product with a weight average molecular weight (Mw) of 6060 g/mole and number average molecular weight (Mn) of 3980 g/mole as determined by GPC with THF eluent against polystyrene standards. A ketone equivalent weight of 288 g/mole was calculated based on NMR.

### Example 3

### Preparation of Polycarbonate Diketone.

ETERNACOLL® PH-100D (100 g, a polycarbonate diol with a reported molecular weight of 1000 g/mole, available from UBE Industries, Ltd.), levulinic acid (29 g), N,N-dicyclohexylcarbodiimide (“DCC”, 51 g), N,N-dimethylaminopyridine (“DMAP”, 6.1 g), and dichloromethane (“DCM”, 250 ml) were combined in a suitable vessel and stirred overnight under nitrogen. The precipitated N,N-dicyclohexylurea (“DCU”) was removed by filtration, and the remaining solution was washed with HCl (1N, 250 ml×2), saturated aqueous NaHCO₃ solution (250 ml×2), and brine (250 ml×2). The organic phase was then dried over anhydrous MgSO₄ and filtered through celite. The solvent was removed to give 95 g of pale yellow liquid, to which 100 ml of methanol was added. After gentle mixing and allowing the layers to separate, the methanol layer was decanted off and the product dried under vacuum to yield 70 g of a colorless liquid. A ketone equivalent weight of 1094 g/mole was calculated by NMR.

### Example 4

### Preparation of a Polycarbonate Diketone.

A polycarbonate diketone was prepared in accordance with procedures of Example 3, using the following reagents: ETERNACOLL® PH-200D (100 g, a polycarbonate diol with a reported molecular weight of 2000 g/mole, available from UBE Industries, Ltd.), levulinic acid (14 g), DCC (25.7 g), DMAP (3.0 g) and DCM (250 ml). Yield: 81 g. A molecular weight of 2938 g/mole and ketone equivalent weight of 1469 g/mole were calculated by NMR.

### Example 5

### Preparation of a Polycaprolactone Mono-Ketone.

### Step-1:

To a solution of 1-octanol (10 g) and caprolactone (131.4 g) in DCM (100 ml) was added diphenyl phosphate (3.85 g) under nitrogen. The solution was stirred at room temperature for 8 hours. The resultant organic solution was washed with saturated aqueous NaHCO₃ solution (250 ml×2) and brine (250 ml×2), followed by a short silica gel plug, eluted using 50/50 DCM and ethyl acetate. The solvent was removed, and the crude product dried under vacuum, resulting in a yield of 140 g. The product was used for the next step without further purification.

### Step-2:

The product of step-1 (140 g) and t-butyl acetoacetate (12.3 g) were together dissolved in toluene (500 ml), and heated at reflux overnight. Volatiles were removed by distillation, then the resulting residue was dried under vacuum to give 150 g of a white solid, which was used directly without further purification. The white solid was determined to have a ketone equivalent weight of 1926 g/mole was calculated from NMR.

### Example 6

### Preparation of Polyurethane Polycarbonate Triketone.

### Step-1:

DESMODUR® N 3200 (2 g) (an aliphatic polyisocyanate available from Covestro) was added dropwise over 1 hour to a solution of ETERNACOLL® PH-300D diol (33 g, a polycarbonate diol with a reported molecular weight of 3000 g/mole, available from UBE Industries, Ltd.) in anhydrous toluene (200 ml) at 75° C. Added 20 mg of dibutyltin dilaurate, and the resultant reaction mixture was stirred for about 6 hours under nitrogen, until isocyanate was completely consumed. The solvent was removed to give 35 g of a crude product, which was directly used in step-2.

### Step-2:

The product from step-1 (25 g), levulinic acid (2.75 g), DCC (4.88 g), DMAP (0.5 g) and DCM (250 ml) were combined and subjected to the same reaction and isolation conditions as described in Example 3. The resulting product had: a yield of 24 g; a molecular weight of 10,500 g/mole; and a ketone equivalent weight of 3500 g/mole. The molecular weight and ketone equivalent weight of the resulting product were in each case calculated by NMR.

### Part 2

### Preparation of Curable Photochromic Compositions

### Comparative Examples CE 7 and CE-8, and Inventive Example 9

Comparative Examples CE 7 and CE 8, and inventive Example 9 were prepared using the components listed in Table 1, shown in parts by weight. The components of Charge 1 were combined and heated to 80° C., stirred for a minimum of 2 hours until the solids were observed to have dissolved completely. Once cooled to room temperature, components of charge 2 were added and the solution was heated to 60° C., stirred for 2 hours until the solids were observed to have dissolved completely. Once cooled to room temperature, the components of Charge 3 were added and the solution stirred for at least 1 hour prior to use.

TABLE 1

| | | CE-7 | CE-8 | Example 9 |
|---|---|---|---|---|
| Charge 1 | Photochromic dye blend A⁽¹⁾ | 8.00 | 8.00 | 8.00 |
| | TINUVIN ® 144⁽²⁾ | 2.00 | 2.00 | 1.99 |
| | IRGANOX ® 245⁽³⁾ | 2.00 | 2.00 | 1.99 |
| | N-methyl pyrrolidinone | 263.6 | 263.6 | 263.6 |
| Charge 2 | Polyhydrazide of Example 1 | 46.4 | 76.6 | 57.4 |
| | BYK ® 333⁽⁴⁾ | 0.08 0.08 | 0.08 | 0.08o. 0.08 |
| | (3-Glycidoxypropyl) trimethoxysilane | 4.5 | 4.5 | 4.5 |
| Charge 3 | Acrylic polyketone of Example 2 | — | 23.4 | 8.8 |
| | Diketone of Example 3 | 53.6 | — | 33.8 |
| | % NV solids (theoretical) | 30 | 30 | 30 |
| | carbonyl:hydrazide ratio | 1:1 | 1:1 | 1:1 |

⁽¹⁾A blend of photochromic indenofused naphthopyran dyes formulated to provide a grey color on activation.
⁽²⁾A hindered amine light stabilizer, commercially available from BASF.
⁽³⁾An antioxidant commercially available from BASF.
⁽⁴⁾A polyether modified dimethylpolysiloxane copolymer, available from BYK-Chemie.

### Examples 10-13

Examples 10-13, which are curable photochromic compositions according to the present invention, were prepared using the components as listed in the following Table 2 (shown in parts by weight), and in accordance with the description provided above with regard to Comparative Examples CE-7 and CE-8, and inventive Example 9.

TABLE 2

| | | Examples | | | |
|---|---|---|---|---|---|
| | | 10 | 11 | 12 | 13 |
| Charge 1 | Photochromic dye blend A⁽¹⁾ | 9.00 | 9.00 | 9.00 | 9.00 |
| | TINUVIN ® 144⁽²⁾ | 2.00 | 2.00 | 2.00 | 2.00 |
| | IRGANOX ® 245⁽³⁾ | 2.00 | 2.00 | 2.00 | 2.00 |
| | N-methyl pyrrolidinone | 263.6 | 263.6 | 263.6 | 209.0 |
| Charge 2 | Polyhydrazide of Example 1 | 51.3 | 57.8 | 64 | 65.9 |
| | BYK ® 333⁽⁴⁾ | 0.08 0.08 | 0.08 | 0.08o. 0.08 | 0.08 0.08 |
| | (3-Glycidoxypropyl) trimethoxysilane | 4.5 | 4.5 | 4.5 | 4.5 |
| Charge 3 | Acrylic polyketone of Example 2 | 7.9 | 11.7 | 15.6 | 17.2 |
| | Diketone of Example 4 | 40.8 | 30.6 | 20.3 | 14.7 |
| | Triketone of Example 6 | — | — | — | 14.7 |
| | % NV solids (theoretical) | 30 | 30 | 30 | 35 |
| | carbonyl:hydrazide ratio | 1:1 | 1:1 | 1:1 | 1:1 |

### Examples 14-17

Examples 14-17, which are curable photochromic compositions according to the present invention, were prepared using the components as listed in the following Table 3 (shown in parts by weight), and in accordance with the description provided above with regard to Comparative Examples CE-7 and CE-8, and inventive Example 9.

TABLE 3

| | | Example | | | |
|---|---|---|---|---|---|
| | Component | 14 | 15 | 16 | 17 |
| Charge 1 | Photochromic dye blend B⁽⁵⁾ | 6.00 | 6.00 | 6.00 | 6.00 |
| | TINUVIN ® 144⁽²⁾ | 2.00 | 2.00 | 2.00 | 2.00 |
| | IRGANOX ® 245⁽³⁾ | 2.00 | 2.00 | 2.00 | 2.00 |
| | N-methyl pyrrolidinone | 207.2 | 209.0 | 209.0 | 209.0 |
| Charge 2 | Polyhydrazide of Example 1 | 57.0 | 65.9 | 65.9 | 65.9 |
| | BYK ® 333⁽⁴⁾ | 0.08 | 0.08 0.08 | 0.08 | 0.08o. 0.08 |
| | (3-Glycidoxypropyl) trimethoxysilane | 4.5 | 4.5 | 4.5 | 4.5 |
| Charge 3 | Acrylic polyketone of Example 2, | 16.3 | 18.7 | 18.7 | 18.7 |
| | 80% in N-methylpyrrolidone | | | | |
| | Monoketone of Example 5 | 30.0 | — | — | — |
| | Diketone of Example 4 | — | 19.1 | 19.1 | 19.1 |
| | Tricresyl phosphate ⁽⁶⁾ | — | — | 19.1 | — |
| | ETERNACOLL PH50⁽⁷⁾ | — | — | — | 19.1 |
| | % NV solids (theoretical) | 35 | 35 | 35 | 35 |
| | carbonyl:hydrazide ratio | 1:1 | 1:1 | 1:1 | 1:1 |

⁽⁵⁾A blend of photochromic indenofused naphthopyran dyes formulated to provide a grey color on activation.
⁽⁶⁾ Material is a liquid at 25° C.
⁽⁷⁾A polycarbonate diol with a molecular weight of 500 g/mole, commercially available from Ube Americas Inc. Material is a liquid at 25° C.

### Examples 18-20

Examples 18-20, which are curable photochromic compositions according to the present invention, were prepared using the components as listed in the following Table 4 (shown in parts by weight), and in accordance with the description provided above with regard to Comparative Examples CE-7 and CE-8, and inventive Example 9.

TABLE 4

| | | Example | | |
|---|---|---|---|---|
| | | 18 | 19 | 20 |
| Charge 1 | Photochromic dye blend B⁽⁵⁾ | 6.00 | 6.00 | 6.00 |
| | TINUVIN ® 144⁽²⁾ | 2.00 | 2.00 | 2.00 |
| | IRGANOX ® 245⁽³⁾ | 2.00 | 2.00 | 2.00 |
| | N-methyl pyrrolidinone | 209.0 | 209.0 | 209.0 |
| Charge 2 | Polyhydrazide of Example 1 | 65.9 | 65.9 | 65.9 |
| | BYK ® 333⁽⁴⁾ | 0.08 | 0.08 | 0.08 |
| | (3-Glycidoxypropyl) | 4.5 | 4.5 | 4.5 |
| | trimethoxysilane | | | |
| | Acrylic polyketone of | 18.7 | 18.7 | 18.7 |
| | Example 2, 80% in N- | | | |
| | methylpyrrolidone | | | |
| | Tricresyl phosphate⁽⁶⁾ | 19.1 | 28.7 | — |
| | Polycaprolactone triol⁽⁸⁾ | — | — | 28.7 |
| | % NV solids (theoretical) | 35 | 35 | 35 |
| | carbonyl:hydrazide ratio | 1:1.33 | 1:1.33 | 1:1.33 |

⁽⁸⁾A polycaprolactone triol having a number average molecular weight of 900 g/mole, obtained commercially from Millipore Sigma (having a Tg of 30° C.).

### Part 3

### Preparation of Photochromic Test Specimens

The compositions of Comparative Examples CE-7 and CE-8, and inventive Examples 9 through 20, were applied to PDQ® coated Gentex® polycarbonate plano lenses, each having a diameter of 76 millimeters. Prior to coating, each lens was treated with corona using Tantec equipment with 70 KV and 1000 W settings. About 2 mL of each composition was dispensed onto the substrate and then rotated for six seconds at a spin speed sufficient to deposit 0.28-0.4 g of wet coating for all coatings (wet weight depends on percent non-volatile solids).

The test specimens of Comparative Examples CE-7 and CE-8, and inventive Examples 9 through 20 were prepared in duplicate, then cured at 125° C. for 1 hour in a forced air electric oven.

### Part 4

### Testing and Test Results of Test Specimens

Part 4a. Micro Hardness Evaluation

One set, of the duplicate set, of test specimens was subjected to an additional thermal cure for three hours at 105° C. and set aside for hardness measurements. These specimens were then subjected to micro-hardness testing using a Fischerscope HCV, Model H100SMC available from Fischer Technology, Inc. The hardness was measured at a penetration depth of 2 microns after a 100 mNewton load for 15 seconds. Each test specimen was measured at least twice and the resulting data was averaged.

Part 4b. Photochromic Performance

The second set, of the duplicate set, of test specimens were further treated with corona as previously described, and spin coated with a protective coating according to the formulation described in Table 1 of Example 1 in U.S. Pat. No. 7,410,691. The test specimens were cured in a UV oven equipped with D bulbs. Following this, each test specimen was thermally cured at 105° C. for three hours.

The photochromic performance of the test specimens was tested on a Bench for Measuring Photochromics (“BMP”) made by Essilor, Ltd. France. The BMP was maintained at a constant temperature of 73.4° F. (23° C.) during testing. Prior to testing, each of the coated test specimens were exposed to 365-nanometer ultraviolet light for about 10 minutes at a distance of about 14 centimeters to activate the photochromic materials. The UVA (315 to 380 nm) irradiance at the lens was measured with a LICOR® Model Li-1800 spectroradiometer and found to be 22.2 watts per square meter. Each test specimen was then placed under a 500 watt, high intensity halogen lamp for about 10 minutes at a distance of about 36 centimeters to bleach (inactivate) the photochromic materials. The illuminance at the specimen was measured with the LICOR® spectroradiometer and found to be 21.9 Klux. Each test specimen was then kept in a dark environment at room temperature (from 70° F. to 75° F., that is 21° C. to 24° C.) for at least one hour prior to testing on the BMP. Prior to measurement, each lens was measured for ultraviolet absorbance at 390 nanometers (Abs 390 nm).

The BMP optical bench was fitted with two 150-watt Newport Model #6255 Xenon arc lamps set at right angles to each other. The light path from Lamp 1 was directed through a 3 mm SCHOTT® KG-2 band-pass filter and appropriate neutral density filters that contributed to the required UV and partial visible light irradiance level. The light path from Lamp 2 was directed through a 3 mm SCHOTT® KG-2 band-pass filter, a SCHOTT® short band 400 nm cutoff filter and appropriate neutral density filters in order to provide supplemental visible light illuminance. A 2 inch×2 inch (5.1 cm×5.1 cm) 50% polka dot beam splitter set at 450 to each lamp is used to mix the two beams. The combination of neutral density filters and voltage control of the Xenon arc lamp were used to adjust the intensity of the irradiance. Software (i.e., BMPSoft version 2.1e) was used on the BMP to control timing, irradiance, air cell and sample temperature, shuttering, filter selection, and response measurement. A ZEISS® spectrophotometer, Model MCS 601, with fiber optic cables for light delivery through the lens was used for response and color measurement. Photopic response measurements were collected on each lens.

The power output of the optical bench (i.e., the dosage of light that the lens was exposed to) was adjusted to 6.7 watts per square meter (W/m²) UVA, integrated from 315-380 nm, and 50 Klux illuminance, integrated from 380-780 nm. Measurement of this power set point was made using an irradiance probe and the calibrated Zeiss spectrophotometer. The lens sample cell was fitted with a quartz window and self-centering sample holder. The temperature in the sample cell was controlled at 23° C. through the software with a modified Facis, Model FX-10, environment simulator. Measurement of the sample's dynamic photochromic response and color measurements were made using the same Zeiss spectrophotometer with fiber optic cables for light delivery from a tungsten halogen lamp through the sample. The collimated monitoring light beam from the fiber optic cable was maintained perpendicular to the test sample while passing through the sample and directed into a receiving fiber optic cable assembly attached to the spectrophotometer. The exact point of placement of the sample in the sample cell was where the activating xenon arc beam and the monitoring light beam intersected to form two concentric circles of light. The angle of incidence of the xenon arc beam at the sample placement point was about 300 from perpendicular.

Response measurements, in terms of a change in optical density (ΔOD) from the unactivated or bleached state to the activated or colored state were determined by establishing the initial unactivated transmittance, opening the shutter from the Xenon lamp(s) and measuring the transmittance through activation at selected intervals of time. Change in optical density was determined according to the formula: ΔOD=log₁₀(% Tb/% Ta), where % T_{b} is the percent transmittance in the bleached state and % Ta is the percent transmittance in the activated state. Optical density measurements were based on photopic optical density.

The results of the micro-hardness and photochromic performance, for Comparative Examples CE-7 and CE-8, and inventive Examples 9 through 20, are shown in Tables 5 to 8. The ΔOD at saturation was after 15 minutes of activation and the Fade Half Life (“T1/2”) value is the time interval in seconds for the ΔOD of the activated form of the photochromic material in the coating to reach one half the fifteen-minute ΔOD at 73.4° F. (23° C.), after removal of the activating light source.

TABLE 5

| | Fischer | | T½ @ | |
|---|---|---|---|---|
| | micro-hardness | | Photopic | Carbonyl:Hydrazide |
| Example | (N/mm²) | ΔOD | (seconds) | ratio |
| CE-7 | 20 | 0.7 | 34 | 1:1 |
| CE-8 | 150 | No activation | | 1:1 |
| 9 | 41 | 0.65 | 34 | 1:1 |

The results as summarized in Table 5 demonstrate that, a comparative photochromic composition including a polyhydrazide with only a second carbonyl-functional material (CE-7) provides a cured comparative photochromic coating that is relatively soft. An analogous comparative curable photochromic composition including only a first polyfunctional carbonyl material (CE-8) provides a cured comparative photochromic coating having very high hardness, but effectively no photochromic activity. With a curable photochromic composition according to the present invention, that includes a combination of the first carbonyl functional material and the second carbonyl functional material, as in Example 9, where the ratio of carbonyl equivalents to hydrazide equivalents is 1:1, provides a cured inventive photochromic coating having a combination of good photochromic performance coupled with increased hardness, relative to CE-7.

TABLE 6

| | Fischer | | T½ @ | |
|---|---|---|---|---|
| | micro-hardness | | Photopic | Carbonyl:Hydrazide |
| Example | (N/mm²) | ΔOD | (seconds) | ratio |
| 10 | 40 | 0.68 | 37 | 1:1 |
| 11 | 54 | 0.67 | 38 | 1:1 |
| 12 | 80 | 0.66 | 46 | 1:1 |
| 13 | 65 | 0.66 | 42 | 1:1 |

The results as summarized in Table 6 demonstrate that, curable photochromic compositions according to the present invention, that include different amounts of first carbonyl and second carbonyl functional materials relative to one another, while maintaining the same ratio of carbonyl group equivalents to hydrazide equivalents, provide cured inventive photochromic coatings having different hardness properties, but in which the photochromic performance properties are not significantly impacted or otherwise altered.

TABLE 7

| | Fischer | | T½ @ | |
|---|---|---|---|---|
| | micro-hardness | | Photopic | Carbonyl:Hydrazide |
| Example | (N/mm²) | ΔOD | (seconds) | ratio |
| 14 | 57 | 0.86 | 45 | 1:1 |
| 15 | 108 | 0.85 | 58 | 1:1 |
| 16 | 59 | 0.87 | 42 | 1:1 |
| 17 | 55 | 0.90 | 51 | 1:1 |

The results as summarized in Table 7 demonstrate that, curable photochromic compositions according to the present invention, that include various mono-functional carbonyl materials, di-functional carbonyl materials, as well as blends of second carbonyl functional materials with non-reactive materials, provide cured inventive photochromic coatings in which photochromic performance properties are decoupled from measured hardness.

TABLE 8

| | Fischer | | T½ @ | |
|---|---|---|---|---|
| | micro-hardness | | Photopic | Carbonyl:Hydrazide |
| Example | (N/mm²) | ΔOD | (seconds) | ratio |
| 18 | 81 | 0.82 | 47 | 1:1.33 |
| 19 | 52 | 0.82 | 39 | 1:1.33 |
| 20 | 54 | 0.86 | 51 | 1:1.33 |

The results as summarized in Table 8 demonstrate that curable photochromic compositions according to the present invention that include a non-reactive material, in the absence of a second carbonyl-functional material, provide cured inventive photochromic coatings having a combination of desirable hardness and desirable photochromic performance properties.

The present invention has been described with reference to specific details of particular embodiments thereof. It is not intended that such details be regarded as limitations upon the scope of the invention except insofar as to the extent that they are included in the accompanying claims.

What is claimed is:

1. A curable photochromic composition comprising:
(a) a photochromic compound;
(b) a hydrazide functional material comprising at least two hydrazide groups that are reactive with carbonyl groups selected from ketone groups and aldehyde groups;
(c) a first carbonyl-functional component comprising a (meth)acrylate polymer having at least two carbonyl groups that are reactive with hydrazide groups, wherein each carbonyl group of said first carbonyl-functional component is independently selected from ketone groups and aldehyde groups; and
(d) at least one of,
(d1) a second carbonyl-functional component comprising at least one carbonyl group that is reactive with hydrazide groups, wherein said second carbonyl-functional component comprises at least one of polycarbonate carbonyl, polyester carbonyl, polyether carbonyl, polyurethane carbonyl, or combinations thereof, wherein each carbonyl group of said second carbonyl-functional component is independently selected from ketone groups and aldehyde groups; or
(d2) a non-reactive component that is free of functional groups that are reactive with said hydrazide functional material, said first carbonyl-functional component, and said second carbonyl-functional component.

2. The curable photochromic composition of claim 1, wherein said hydrazide functional material has a hydrazide equivalent weight of from 250 g/mole to 10,000 g/mole, and a Mw of from 500 g/mole to 50,000 g/mole.

3. The curable photochromic composition of claim 1, wherein said hydrazide functional material comprises a polyurethane comprising at least two hydrazide groups that are reactive with carbonyl groups selected from ketone groups and aldehyde groups.

4. The curable photochromic composition of claim 1, wherein said hydrazide functional material comprises from 2 to 60 hydrazide groups that are reactive with carbonyl groups selected from ketone groups and aldehyde groups.

5. The curable photochromic composition of claim 1, wherein at least some hydrazide groups of said hydrazide functional material are independently and reversibly blocked with an aldehyde having a formula weight of less than 250 g/mole, or a ketone having a formula weight of less than 250 g/mole.

6. The curable photochromic composition of claim 1, wherein a ratio, of total carbonyl equivalents of said first carbonyl-functional component and said second carbonyl-functional component to total equivalents of hydrazide equivalents of said hydrazide functional material, is from 1:0.8 to 1:4.

7. The curable photochromic composition of claim 1, wherein said first carbonyl-functional component comprises at least two ketone groups, and said second carbonyl-functional component comprises at least one ketone group.

8. The curable photochromic composition of claim 1, wherein the (meth)acrylate polymer of said first carbonyl-functional component comprises ketone functional (meth)acrylamide monomer residues.

9. The curable photochromic composition of claim 1, wherein the (meth)acrylate polymer of said first carbonyl-functional component has a carbonyl equivalent weight of from 165 g/mole to 550 g/mole, and a Mw of from 1000 g/mole to 10,000 g/mole.

10. The curable photochromic composition of claim 1, wherein said second carbonyl-functional component has an equivalent weight of from 580 g/mole to 10,000 g/mole, and a Mw of from 580 g/mole to 40,000 g/mole.

11. The curable photochromic composition of claim 1, wherein said non-reactive component has,
a Tg of less than 50° C., when said non-reactive component is an amorphous polymeric non-reactive component, or
a melting point of less than 50° C., when said non-reactive component is a crystalline non-reactive component.

12. The curable photochromic composition of claim 11, wherein said non-reactive component comprises at least one of polyethers, polyesters, polycarbonates, polyurethanes, and organo phosphates.

13. The curable photochromic composition of claim 1, wherein said second carbonyl-functional component and said non-reactive component are present in a combined amount of from 10 percent by weight to 50 percent by weight, based on total resin solids of said curable photochromic composition.

14. The curable photochromic composition of claim 1, wherein said second carbonyl-functional component is present, and said non-reactive component is optionally present.

15. The curable photochromic composition of claim 1, wherein said photochromic compound (a) comprises at least one of naphthopyrans, benzopyrans, phenanthropyrans, indenonaphthopyrans, spiro(indoline)naphthoxazines, spiro(indoline)pyridobenzoxazines, spiro(benzindoline)pyridobenzoxazines, spiro(benzindoline)naphthoxazines, spiro(indoline)-benzoxazines, fulgides, fulgimides, or diarylethenes.

16. An article comprising:
(A) a substrate; and
(B) a photochromic layer over at least one surface of the substrate, wherein the photochromic layer is formed from the curable photochromic composition of claim 1.
